(19) United States
(12) Patent Application Publication
(10) Pub. No.: US 2009/0020366 A1
(43) Pub. Date: Jan. 22, 2009

(54) LUBRICATION APPARATUS

(75) Inventors: Taiithi Mori, Shizuoka-ken (JP); Tametoshi Mizuta, Shizuoka-ken (JP); Katuhiko Arisawa, Shizuoka-ken (JP); Yoshio Yamashita, Shizuoka-ken (JP); Hideo Kobayashi, Shizuoka-ken (JP); Kenichi Yamada, Shizuoka-ken (JP); Kunihiko Hayashi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA

(21) Appl. No.: 11/817,750

(22) PCT Filed: Feb. 6, 2006
(86) PCT No.: PCT/JP2006/302407

§ 371 Date: Sep. 4, 2007

(30) Foreign Application Priority Data
Mar. 2, 2005 (JP) 2005-56873
Aug. 31, 2005 (JP) 2005-250989

(51) Int. Cl. F16N 31/00

(52) U.S. Cl. 184/106

(57) ABSTRACT

An oil pan (130) comprises an oil pan cover (131) storing oil in an internal space and an oil pan separator (132) positioned in the internal space. The oil pan separator (132) is positioned so as to divide the internal space into a first chamber (30a), which has an oil strainer (41) at its bottom, and a second chamber (30b), which is adjacent to the first chamber (30a). The oil pan separator (132) includes a slope plate (132c) for capturing return oil that flows back from a cylinder block (20a) to an oil pan (130). Part of the captured return oil flows to the second chamber (30b) via a communication hole (132f) that is provided in the slope plate (132c). The remaining captured return oil flows into the first chamber (30a). This ensures that the oil level in the second chamber (30b) is higher than that in the first chamber (30a). Therefore, when a solenoid valve (133) opens at the end of a warm-up operation, the oil in the second chamber (30b) flows into the first chamber (30a).

### TECHNICAL FIELD

The present invention relates to an oil pan that is capable of storing oil for lubricating a lubrication target mechanism (e.g., engine block or automatic transmission mechanism). The present invention also relates to a lubrication apparatus equipped with the oil pan (e.g., engine or automatic transmission).

### BACKGROUND ART

In general, the lubrication apparatus of the above-mentioned type is configured so that the oil stored in the oil pan is taken in by an oil pump and supplied to lubrication target members (e.g., a gear, a camshaft, a cylinder, and a piston) in the lubrication target mechanism. Further, the lubrication apparatus is configured so that the oil lubricates the lubrication target members, absorbs friction-induced heat and other heat from the lubrication target members, and then flows back (returns) to the inside of the oil pan from the lubrication target mechanism due to gravity.

A so-called two-tank oil pan structure is widely known as the oil pan structure for reducing the warm-up time during the use of the lubrication apparatus of the above-mentioned type (refer, for instance, to Patent Reference 1 below).

[Patent Reference 1] Japanese Patent JP-A No. 222012/2003

In an apparatus disclosed by Patent Reference 1, an oil pan separator is positioned in an internal space of the oil pan. The oil pan separator is a member for dividing the internal space of the oil pan into two sections (a first chamber and a second chamber). The first chamber is a space that is open toward an engine block, which is a lubrication target mechanism. The first chamber communicates with the engine block so as to receive oil that flows back (returns) from the engine block to the oil pan. The bottom of the first chamber is provided with an oil strainer that is connected to the oil pump to constitute an oil intake port for taking in the oil in the first chamber. The second chamber is adjacent to the first chamber so that the interchange of oil may occur in a predetermined oil communication path between the first chamber and the second chamber.

The above apparatus is configured so that the interchange of oil between the first chamber and the second chamber is limited during a warm-up operation when compared to a post-warm-up period. It means that the progress of the warm-up operation is facilitated. In other words, the above apparatus is configured so as to limit the oil inflow from the second chamber to the first chamber while the oil circulates between the engine block and the first chamber. This reduces the amount of oil circulation within the apparatus during a warm-up operation. Therefore, the temperatures of the oil and the lubrication target members rise rapidly so that the warm-up period of the apparatus may be decreased. Further, the above-mentioned limitation is eased or lifted after termination of the warm-up operation. The oil stored in the second chamber then flows into the first chamber so that the oil in the first chamber and the second chamber circulates between the engine block and the oil pan.

### DISCLOSURE OF THE INVENTION

When the apparatus disclosed by Patent Reference 1 includes an oil flow path for allowing oil to flow from the second chamber to the first chamber via the oil communication path and become taken in by the oil strainer, the oil flow resistance in the oil flow path is regarded as R₂₋₁. Also, when the apparatus includes an oil flow path for allowing the oil stored in the first chamber to be taken in by the oil strainer, the oil flow resistance in the oil flow path is regarded as R₁₋₁. In this instance, R₂₋₁ is greater than R₁₋₁. Therefore, as is the case with a warm-up period, the oil in the first chamber is mainly taken in by the oil strainer and supplied to the lubrication target mechanism even after termination of the warm-up operation. Consequently, the oil stored in the second chamber of the apparatus is not readily used for oil circulation between the engine block and the oil pan. Thus, the oil stored in the oil pan (particularly the oil continuously stored in the first chamber) deteriorates early.

The present invention has been made to solve the above problem. It is an object of the present invention to provide a lubrication apparatus that has a two-tank oil pan structure for reducing the warm-up period and circulates the oil stored in the oil pan between the oil pan and the lubrication target mechanism as uniformly as possible.

(1) The configuration according to the present invention will now be described. The lubrication apparatus according to the present invention comprises an oil pan, an oil pump for supplying oil stored in the oil pan to the lubrication target mechanism, and an oil strainer that is positioned in the aforementioned internal space to constitute an oil intake port for the oil pump. The oil pan according to the present invention comprises an oil pan cover capable of storing oil for lubricating the lubrication target mechanism in an internal space and an oil pan separator that is positioned in the internal space.

The oil pan separator is positioned so as to divide the internal space of the oil pan cover, which can store the oil, into a first chamber, which has the oil strainer at its bottom, and a second chamber, which is adjacent to the first chamber. The oil pan separator is provided with an oil communication path that permits the interchange of oil between the first chamber and the second chamber. The oil communication path is configured so that the interchange of oil between the first chamber and the second chamber varies with the operation of the lubrication target mechanism (e.g., the progress of a warm-up operation). More specifically, the interchange of oil in the oil communication path between the first chamber and the second chamber is limited during a warm-up operation (the oil communication path is closed), whereas such a limitation is eased or lifted after termination of the warm-up operation (the oil communication path is opened).

(1-1) The present invention is characterized by the fact that the lubrication apparatus and the oil pan, which are configured as described above, include a first oil return path and a second oil return path to achieve the above object. The first oil return path is configured so that the return oil, which flows back from the lubrication target mechanism to the oil pan, is introduced into the first chamber. The second oil return path is configured so as to introduce the return oil to the second chamber.

In the configuration described above, the oil pump takes in the oil from the first chamber via the oil strainer. The oil is then supplied to the lubrication target mechanism by the oil pump. The supplied oil not only lubricates the lubrication target mechanism but also absorbs heat (e.g., friction-induced heat) from the lubrication target mechanism. Next, the oil returns to the oil pan. The return oil, which flows back from the lubrication target mechanism to the oil pan, is introduced into the first chamber via the first oil return path. This accelerates the oil temperature rise in the first chamber as well as the warm-up operation.

The return oil is also introduced into the second chamber via the second oil return path. Therefore, the return oil can also be distributed to the second chamber during a warm-up operation. Thus, the return oil can also be stored in the second chamber. The oil stored in the second chamber during the warm-up operation (the oil level rise in the second chamber) may accelerate the oil inflow from the second chamber to the first chamber via the oil communication path when the oil communication path opens upon termination of the warm-up operation.

It is preferred that the first and second oil return paths be formed to ensure that (when the first and second chambers both have a free space for storing the return oil) the amount of return oil inflow to the first chamber via the first oil return path is larger than the amount of return oil inflow to the second chamber via the second oil return path. This causes the return oil, which has absorbed heat from the lubrication target mechanism, to flow into the first chamber, thereby properly accelerating the progress of the warm-up operation.

(1-2) The lubrication apparatus and the oil pan that are configured as described under (1-1) above may be configured as described below. The oil pan separator is provided with a first concave that is open toward the lubrication target mechanism in order to constitute the first chamber. The second chamber is positioned outside the first chamber as it is formed by a space that is enclosed by the oil pan cover and the outer surface of the first concave in the oil pan separator. The first oil return path is provided so that the lubrication mechanism and the first concave communicate with each other.

In the configuration described above, the return oil, which flows back from the lubrication target mechanism to the oil pan, is introduced into the first chamber, which is formed by the internal space of the first concave, via the first oil return path, which is installed to provide communication between the lubrication target mechanism and the first concave formed in the oil pan separator.

In the configuration described above, the first chamber can be formed by using a simple configuration when the first concave is formed in the oil pan separator. Further, the second chamber, which is positioned outside the first chamber, forms a heat insulation layer between the first chamber and outside air. Therefore, the oil temperature rise in the first chamber can be accelerated during a warm-up operation.

It is preferred that the oil pan separator be made of a plate-like member. It is also preferred that when viewed from the top, the first concave, which is open toward the lubrication target mechanism, be formed substantially at the center of the oil pan separator (that is, the oil pan separator be shaped like a bathtub). This simplifies the configuration of the oil pan separator, thereby reducing the cost of manufacturing the lubrication apparatus and the oil pan.

(1-3) The lubrication apparatus and the oil pan that are configured as described under (1-1) or (1-2) above may further comprise a return oil guide section. The return oil guide section includes a second concave that faces and communicates with the lubrication target mechanism and is open toward the lubrication target mechanism. The bottom of the return oil guide section is provided with a first communication hole for communicating with the first chamber and a second communication hole for communicating with the second chamber. The first oil return path is formed by the first communication hole, whereas the second oil return path is formed by the second communication hole.

In the configuration described above, the return oil, which flows back from the lubrication target mechanism to the oil pan, is temporarily received by the second concave, which is formed by the return oil guide section. The received oil is then introduced into the first and second chambers via the first and second communication holes.

It is preferred that the first and second communication holes be formed to ensure that (when the first and second chambers both have a free space for storing the return oil) the amount of return oil inflow to the first chamber via the first communication hole is larger than the amount of return oil inflow to the second chamber via the second communication hole.

Further, it is preferred that the return oil guide section be made of a bathtub-shaped member, which is formed by a plate-like member, and that the first communication hole be formed in a partition that is positioned to separate the first chamber from the second concave, which is open toward the lubrication target mechanism. This ensures that the area around the first communication hole in the partition faces the first chamber and can function as a baffle plate. Therefore, the return oil guide section can be made integral with the baffle plate. The baffle plate is a member that is positioned in the oil pan to inhibit the oil in the oil pan (in the first chamber) from undulating.

(1-4) As for the lubrication apparatus and the oil pan that are configured as described under (1-3) above, the return oil guide section may be made integral with the oil pan separator. The configurations of the lubrication apparatus and the oil pan are then simplified to a greater extent.

(1-5) As for the lubrication apparatus and the oil pan that are configured as described under (1-3) or (1-4) above, the oil communication path may be positioned lower than the return oil guide section.

In the configuration mentioned above, the return oil flows back to the second chamber via the return oil guide section, which is positioned higher than the oil communication path. The return oil can then be stored in the second chamber. Further, after termination of a warm-up operation, the oil stored in the second chamber flows into the first chamber via the oil communication path, which is positioned lower than a level at which the return oil flows back to the second chamber.

In the configuration described above, the flow of the oil (return oil), which flows back to the first chamber from the return oil guide section via the second oil return path and the second chamber, can be accelerated after termination of a warm-up operation. Therefore, the oil can sufficiently circulate within the oil pan after termination of the warm-up operation.

For example, the above configuration can be achieved by providing the bottom of the first chamber with the oil communication path. The bottom of the first chamber may denote a position near the oil strainer. Alternatively, the bottom of the first chamber may denote a position that is lower than the “L (low) level” mark on the rod-like oil level gauge, which permits the visual inspection of the oil level in the first chamber.

(1-6) As for the lubrication apparatus and the oil pan that are configured as described under (1-1) or (1-2) above, the second oil return path may be formed by an oil return through-hole that is provided in the oil pan separator to let the first chamber communicate with the upper section of the second chamber.

In other words, the configurations of the lubrication apparatus and the oil pan are as described below. The lubrication apparatus includes the oil pan, the oil pump, and the oil strainer as described under (1) above. The oil pan comprises the oil pan cover and the oil pan separator as described under (1) above. As for the lubrication apparatus and the oil pan, the oil pan separator provides a partition between the upper sections of the first chamber and the second chamber. Further, the oil return through-hole is formed in the partition between the upper sections of the first chamber and the second chamber, which is provided in the oil pan separator.

In the configuration described above, the return oil, which flows back from the lubrication target mechanism to the oil pan, first flows into the upper section of the first chamber and then flows into the upper section of the second chamber via the oil return through-hole, which is formed in the oil pan separator. In other words, the return oil flows back to the upper section of the second chamber via the upper section of the first chamber.

In the configuration described above, the return oil may flow back to the upper sections of the first chamber and the second chamber during a warm-up operation. This accelerates the oil temperature rise in the first chamber during the warm-up operation. Further, the oil level in the second chamber may rise during the warm-up operation to make an effective oil level difference (pressure difference) between the first chamber and the second chamber. Due to the pressure difference, the oil in the second chamber flows into the first chamber via the oil communication path at the end of the warm-up operation. Therefore, the oil sufficiently circulates within the oil pan after termination of the warm-up operation.

(1-7) As for the lubrication apparatus and the oil pan that are configured as described under (1-6) above, the oil return through-hole may be formed at a position corresponding to an apex of the second chamber that prevails while the lubrication target mechanism is operative.

When a predetermined machine (e.g., vehicle) in which the lubrication apparatus configured as described above is mounted is made operative, the oil return through-hole is positioned at an apex of a vertical direction of the second chamber. The oil return through-hole functions not only as the second oil return path but also as an air-bleeding hole for discharging air upward from the second chamber at the time, for instance, of an oil change.

(1-8) As for the lubrication apparatus and the oil pan that are configured as described under (1-6) or (1-7) above, the oil return through-hole may be formed so as to permit the insertion of an oil level gauge. As is well known, the oil level gauge comprises a gauge main body (rod section), which is made of a rod-like member, and a gauge section, which is positioned at an end of the gauge main body. The gauge section is configured so as to permit the visual inspection of the oil level in the first chamber.

While the lubrication apparatus configured as described above is operating, the oil level gauge (gauge section) is left inserted in the oil return through-hole. While the oil level gauge is inserted in the oil return through-hole, the return oil flows back to the second chamber as it passes through a gap between the oil return through-hole and the oil level gauge.

When the oil level in the first chamber is to be confirmed, the oil level gauge is removed from the oil return through-hole after the lubrication apparatus stops operating. Next, the oil level gauge is taken out of the lubrication apparatus.

Further, when the oil is to be changed, the oil level gauge is removed from the oil return through-hole after the operation of the lubrication apparatus is stopped, and then taken out of the lubrication apparatus. Next, the pipe connected to an oil changer, which is used to change the oil in the oil pan, is inserted into the oil return through-hole.

(1-9) The lubrication apparatus and the oil pan that are configured as described under (1-1) or (1-2) may further comprise a return oil storage section. The bottom of the return oil storage section may be provided with a communication hole that constitutes the second oil return path and communicates with the second chamber. The return oil storage section includes a second concave that faces and communicates with the lubrication target mechanism and is open toward the lubrication target mechanism. Further, the second concave is capable of storing the return oil.

In the configuration described above, the return oil, which flows back from the lubrication target mechanism to the oil pan, temporarily flows into the return oil storage section (second concave). Subsequently, the return oil, which is stored in the return oil storage section, flows into the second chamber via the communication hole that constitutes the second oil return path.

(1-10) The lubrication apparatus and the oil pan that are configured as described under (1-9) may further comprise a lateral partition plate that constitutes a sidewall of the return oil storage section.

In the configuration described above, the sidewall of the return oil storage section is constituted by the lateral partition plate. Therefore, the return oil storage section can be formed by using a simple apparatus configuration.

More specifically, the return oil storage section for the lubrication apparatus and the oil pan that are described under (1-9) above may comprise the lateral partition plate and an upper partition plate. The upper partition plate is positioned to provide a partition between the return oil storage section and the upper section of the second chamber. The upper partition plate is provided with the communication hole. The lateral partition plate is positioned above the upper partition plate so as to stand on the upper partition plate.

In the configuration described above, the return oil, which flows back from the lubrication target mechanism to the oil pan, temporarily flows into a concave (second concave) that is enclosed by the upper partition plate and the lateral partition plate, that is, temporarily flows into the return oil storage section. Subsequently, the return oil, which is stored in the concave (return oil storage section), flows into the second chamber via the communication hole that constitutes the second oil return path.

The amount of return oil stored in the return oil storage section depends on the dimensions (particularly the height) of the lateral partition plate. Therefore, the dimensions of the lateral partition plate (that is, the return oil storage amount) can be set as appropriate so that the oil properly circulates in the lubrication target mechanism, the lubrication apparatus, and the oil pan in every operation mode for the lubrication target mechanism and the lubrication apparatus.

For example, the height of the lateral partition plate may be increased to a certain degree for the sake of convenience. More specifically, this applies to a situation where the employed configuration does not allow the communication hole to provide communication until the return oil temperature is raised to a predetermined level. This configuration may be employed, for instance, in a situation where the communication hole has a small diameter (e.g., approximately 1 to 5 mm) that does not readily allow low-temperature, high-viscosity oil to pass through or in a situation where the communication hole is provided with a valve mechanism that opens/closes in accordance with the return oil temperature or the like.

In the above situations, a relatively large amount of return oil is stored in the return oil storage section before the return oil reaches a predetermined high temperature (during a warm-up operation). When the return oil temperature reaches the predetermined high temperature, the return oil flows into the upper section of the second chamber via the communication hole. This ensures that the oil circulates with increased vigorousness between the first chamber and the second chamber. Therefore, the lubrication target mechanism can be properly lubricated and cooled.

Meanwhile, it is preferred that the lateral partition plate be positioned low (not too high) to prevent the amount of oil in the first chamber from being insufficient at a cold start (particularly when the engine is started at an extremely low temperature).

(1-11) As for the lubrication apparatus and the oil pan that are configured as described under (1-9) or (1-10) above, the return oil storage section may be integral with the oil pan separator. This may reduce the number of parts that are required for the lubrication apparatus and the oil pan. Therefore, it is possible to reduce the manpower requirements for manufacturing the lubrication apparatus and the oil pan.

(1-12) As for the lubrication apparatus and the oil pan that are configured as described under (1-9) to (1-11) above, the oil communication path may be positioned lower than the return oil storage section.

In the configuration described above, the return oil is temporarily stored in the return oil storage section, which is positioned higher than the oil communication path, and then returned to the second chamber via the second oil return path. This ensures that the return oil can be stored in the second chamber. After termination of a warm-up operation, the oil stored in the second chamber flows into the first chamber via the oil communication path, which is positioned lower than the return oil storage section. The configuration described above can be achieved easily when, for instance, the bottom of the first chamber is provided with the oil communication path.

In the configuration described above, the flow of the return oil, which flows back to the first chamber from the return oil storage section via the second oil return path and the second chamber, can be accelerated after termination of a warm-up operation. Therefore, the oil can sufficiently circulate within the oil pan after termination of the warm-up operation.

(1-13) As for the lubrication apparatus and the oil pan that are configured as described under (1-9) to (1-12) above, the communication hole may be formed at a position corresponding to an apex of the second chamber that prevails while the lubrication target mechanism is operative.

When the predetermined machine in which the lubrication apparatus configured as described above is mounted is made operative, the communication hole is positioned at an apex of a vertical direction of the second chamber. The communication hole functions not only as the second oil return path but also as the aforementioned air-bleeding hole.

(1-14) As for the lubrication apparatus and the oil pan that are configured as described under (1-9) to (1-13) above, the communication hole may be formed so as to accept the insertion of the aforementioned oil level gauge.

In the configuration described above, the oil level gauge is inserted in the communication hole while the lubrication apparatus is operating. When the return oil passes through a gap between the communication hole and the oil level gauge while the oil level gauge is inserted in the communication hole, the return oil flows back into the second chamber.

When the oil is to be changed or the oil level in the first chamber is to be confirmed, the oil level gauge is removed from the communication hole with the operation of the lubrication apparatus stopped.

(1-15) As for the lubrication apparatus and the oil pan that are configured as described under (1-1) to (1-14) above, the oil communication path may be provided with a first valve that can open/close in accordance with the oil temperature in the first chamber.

In the configuration described above, the first valve may open/close in accordance with the operation of the lubrication target mechanism. This ensures that the interchange of oil between the first chamber and the second chamber can be properly controlled in accordance with the operation of the lubrication target mechanism.

(1-16) As for the lubrication apparatus and the oil pan that are configured as described under (1-1) to (1-15) above, the second oil return path may be provided with a second valve that can open/close in accordance with the temperature of the return oil.

In the configuration described above, the second valve may open/close in accordance with the operation of the lubrication target mechanism. The backflow of the return oil to the second chamber via the second oil return path can then be properly controlled in accordance with the operation of the lubrication target mechanism.

(1-17) The lubrication apparatus and the oil pan that are configured as described under (1-16) above may further comprise an open/close operation interlock section for ensuring that the open/close operation of the first valve and the open/close operation of the second valve are interlocked with each other.

In the configuration described above, the first valve can open/close in accordance with the operation of the lubrication target mechanism. Further, the open/close operation interlock section can interlock the open/close operation of the second valve with that of the first valve. This ensures that the oil interchange between the first chamber and the second chamber and the backflow of the return oil to the second chamber via the second oil return path can be properly controlled in accordance with the operation of the lubrication target mechanism.

(1-18) As for the lubrication apparatus and the oil pan that are configured as described under (1-17) above, the open/close operation interlock section may be made of a wire member that is installed as a bridge between the first valve and the second valve.

In the configuration described above, the open/close operations of the first valve and the second valve can be interlocked with each other mechanically and properly via the wire member.

(1-19) As for the lubrication apparatus and the oil pan that are configured as described under (1-1) to (1-18) above, the oil communication path may be positioned lower than the oil level in the first chamber that prevails when the lubrication target mechanism is operative.

In the configuration described above, the hydraulic pressure within the oil communication path can be raised. Therefore, the oil communication path pressure difference between the first chamber and the second chamber can be maximized. Therefore, the oil interchange in the oil communication path between the first chamber and the second chamber can be made vigorous after termination of a warm-up operation to ensure that the oil sufficiently circulates within the oil pan.

(2) The lubrication apparatus according to the present invention comprises an oil pan, an oil pump for supplying oil stored in the oil pan to the lubrication target mechanism, and an oil strainer that is positioned in the aforementioned internal space to constitute an oil intake port for the oil pump. The oil pan according to the present invention comprises an oil pan cover that is capable of storing oil for lubricating the lubrication target mechanism in an internal space, and an oil pan separator that is positioned in the internal space.

The oil pan separator is positioned so as to divide the internal space of the oil pan cover, which can store the oil, into a first chamber, which has the oil strainer at its bottom, and a second chamber, which is adjacent to the first chamber. The oil pan separator is provided with an oil communication path that permits the interchange of oil between the first chamber and the second chamber. The oil communication path is configured so that the interchange of oil between the first chamber and the second chamber varies with the operation of the lubrication target mechanism (e.g., the progress of a warm-up operation). More specifically, the interchange of oil in the oil communication path between the first chamber and the second chamber is limited during a warm-up operation (the oil communication path is closed), whereas such a limitation is eased or lifted after termination of the warm-up operation (the oil communication path is opened).

(2-1) The present invention is characterized by the fact that the lubrication apparatus and the oil pan, which are configured as described under (2) above, include an oil return path to achieve the aforementioned object. The oil return path is configured so that the return oil, which flows back from the lubrication target mechanism to the oil pan, can be introduced into the first chamber.

In the configuration described above, the oil pump takes in the oil from the first chamber via the oil strainer. The oil is then supplied to the lubrication target mechanism by the oil pump. The supplied oil not only lubricates the lubrication target mechanism but also absorbs heat from the lubrication target mechanism. Next, the oil returns to the oil pan.

Part of the return oil, which flows back from the lubrication target mechanism to the oil pan, is then introduced into the second chamber via the oil return path. The return oil can therefore be stored in the second chamber during a warm-up operation. The remaining portion of the return oil flows back to the first chamber. This accelerates the oil temperature rise in the first chamber as well as the warm-up operation.

The oil stored in the second chamber during the warm-up operation (the oil level rise in the second chamber) can accelerate the oil flow from the second chamber to the first chamber via the oil communication path when the oil communication path opens upon termination of the warm-up operation.

It is preferred that the oil return path be formed to ensure that (when the first and second chambers both have a free space for storing the return oil) the amount of return oil inflow to the first chamber is larger than the amount of return oil inflow to the second chamber via the oil return path. This causes the return oil, which has absorbed heat from the lubrication target mechanism, to flow into the first chamber, thereby properly accelerating the progress of the warm-up operation.

(2-2) As for the lubrication apparatus and the oil pan that are configured as described under (2-1) above, the oil return path may be formed by an oil return through-hole that is made in the oil pan separator to provide communication between the upper sections of the first chamber and the second chamber.

In other words, the lubrication apparatus and the oil pan are configured as described below. The lubrication apparatus comprises the oil pan, the oil pump, and the oil strainer as described under (2) above. The oil pan comprises the oil pan cover and the oil pan separator as described under (2) above. In the lubrication apparatus and the oil pan, the oil pan separator provides a partition between the upper sections of the first chamber and the second chamber. As regards the oil pan separator, the oil return through-hole is formed in the partition between the upper sections of the first chamber and the second chamber.

In the configuration described above, the return oil first flows into the upper section of the first chamber, and then flows into the upper section of the second chamber via the oil return through-hole. In other words, the return oil flows back to the upper section of the second chamber via the upper section of the first chamber.

When the configuration described above is employed, the return oil can flow back to the upper sections of the first chamber and the second chamber during a warm-up operation. This accelerates the oil temperature rise in the first chamber. Further, the oil level in the second chamber can rise during the warm-up operation. At the end of the warm-up operation, the oil in the second chamber flows into the first chamber via the oil communication path due to a pressure difference between the first chamber and the second chamber, which is invoked by an oil level rise in the second chamber. Therefore, the oil can sufficiently circulate within the oil pan after termination of the warm-up operation.

(2-3) As for the lubrication apparatus and the oil pan that are configured as described under (2-2) above, the oil return through-hole may be formed at a position corresponding to an apex of the second chamber that prevails while the lubrication target mechanism is operative.

When a predetermined machine in which the lubrication apparatus configured as described above is mounted is made operative, the oil return through-hole is positioned at an apex of a vertical direction of the second chamber. The oil return through-hole functions not only as the oil return path but also as the aforementioned air-bleeding hole.

(2-4) As for the lubrication apparatus and the oil pan that are configured as described under (2-2) or (2-3) above, the oil return through-hole may be formed so as to accept the insertion of the aforementioned oil level gauge.

In the configuration described above, the return oil passes through a gap between the oil return through-hole and the oil level gauge while the oil level gauge is inserted in the oil return through-hole during an operation of the lubrication apparatus. This causes the return oil to flow back into the second chamber.

When, for instance, the oil is to be changed, the oil level gauge is removed from the oil return through-hole with the operation of the lubrication apparatus stopped.

(2-5) The lubrication apparatus and the oil pan that are configured as described under (2-1) above may further comprise a return oil storage section. The bottom of the return oil storage section may be provided with a communication hole that communicates with the second chamber and constitutes the oil return path. The return oil storage section includes a return oil storage concave that faces and communicates with the lubrication target mechanism and is open toward the lubrication target mechanism. The return oil storage concave is capable of storing the return oil.

In the configuration described above, the return oil, which flows back from the lubrication target mechanism to the oil pan, temporarily flows into the return oil storage section (return oil storage concave). Subsequently, the return oil, which is stored in the return oil storage section, flows into the second chamber via the communication hole that constitutes the oil return path.

(2-6) The lubrication apparatus and the oil pan that are configured as described under (2-5) above may further comprise a lateral partition plate that constitutes a sidewall of the return oil storage section.

More specifically, the return oil storage section for the lubrication apparatus and the oil pan that are described under (2-5) above may comprise the lateral partition plate and an upper partition plate. The upper partition plate is positioned to provide a partition between the return oil storage section and the upper section of the second chamber. The upper partition plate is provided with the communication hole. The lateral partition plate is positioned above the upper partition plate so as to stand on the upper partition plate.

In the configuration described above, the return oil, which flows back from the lubrication target mechanism to the oil pan, temporarily flows into a concave (second concave) that is enclosed by the upper partition plate and the lateral partition plate, that is, temporarily flows into the return oil storage section. Subsequently, the return oil, which is stored in the concave (return oil storage section), flows into the second chamber via the communication hole that constitutes the second oil return path.

As described earlier, the dimensions of the lateral partition plate (return oil storage amount) can be set as appropriate so that the oil properly circulates in the lubrication target mechanism, the lubrication apparatus, and the oil pan in every operation mode for the lubrication target mechanism and the lubrication apparatus.

(2-7) As for the lubrication apparatus and the oil pan that are configured as described under (2-5) or (2-6) above, the return oil storage section may be integral with the oil pan separator. This makes it possible to reduce the manpower requirements for manufacturing the lubrication apparatus and the oil pan.

(2-8) As for the lubrication apparatus and the oil pan that are configured as described under (2-5), (2-6), or (2-7) above, the oil communication path may be positioned lower than the return oil storage section.

In the configuration described above, the return oil is temporarily stored in the return oil storage section, which is positioned higher than the oil communication path, and then returned to the second chamber via the oil return path. The return oil can then be stored in the second chamber. After termination of a warm-up operation, the oil stored in the second chamber flows into the first chamber via the oil communication path, which is positioned lower than the return oil storage section. The configuration described above can easily be achieved by providing the bottom of the first chamber with the oil communication path.

The above configuration can further accelerate the flow of the oil (return oil) that flows back from the return oil storage section to the first chamber via the oil return path and the second chamber after termination of a warm-up operation. Therefore, the oil can sufficiently circulate within the oil pan after termination of a warm-up operation.

(2-9) As for the lubrication apparatus and the oil pan that are configured as described under (2-5) to (2-8) above, the communication hole may be formed at a position corresponding to an apex of the second chamber that prevails while the lubrication target mechanism is operative.

When a predetermined machine in which the lubrication apparatus configured as described above is mounted is made operative, the communication hole is positioned at an apex of a vertical direction of the second chamber. The communication hole doubles as the aforementioned air-bleeding hole.

(2-10) As for the lubrication apparatus and the oil pan that are configured as described under (2-5) to (2-9) above, the communication hole may be formed so as to accept the insertion of the aforementioned oil level gauge.

In the configuration described above, the oil level gauge is inserted in the communication hole while the lubrication apparatus is operating. When the return oil passes through a gap between the communication hole and the oil level gauge while the oil level gauge is inserted in the communication hole, the return oil flows back into the second chamber.

When, for instance, the oil is to be changed, the oil level gauge is removed from the communication hole with the operation of the lubrication apparatus stopped.

(2-11) As for the lubrication apparatus and the oil pan that are configured as described under (2-1) to (2-10) above, the oil communication path may be positioned lower than the oil return path.

In the configuration described above, the return oil flows back to the second chamber via the oil return path, which is positioned higher than the oil communication path. The return oil can then be stored in the second chamber. After termination of a warm-up operation, the oil stored in the second chamber flows into the first chamber via the oil communication path that is positioned lower than the oil return path through which the return oil flows back to the second chamber.

The above configuration can further accelerate the flow of the oil (return oil) that flows back to the first chamber via the oil return path and the second chamber after termination of a warm-up operation. Therefore, the oil can sufficiently circulate within the oil pan after termination of a warm-up operation.

(2-12) As for the lubrication apparatus and the oil pan that are configured as described under (2-1) to (2-11) above, the oil pan separator may be provided with a first chamber formation concave that is open toward the lubrication target mechanism to constitute the first chamber. The second chamber may be formed by a space that is enclosed by the oil pan cover and the outer surface of the first chamber formation concave in the oil pan separator, and positioned outside the first chamber.

In the configuration described above, the first chamber can be formed by using a simple configuration when the oil pan separator is provided with the first chamber formation concave. Further, the second chamber, which is positioned outside the first chamber, forms a heat insulation layer between the first chamber and outside air. Therefore, the oil temperature rise in the first chamber can be accelerated during a warm-up operation.

It is preferred that the oil pan separator be made of a plate-like member. It is also preferred that when viewed from the top, the first chamber formation concave, which is open toward the lubrication target mechanism, be formed substantially at the center of the oil pan separator (that is, the oil pan separator be shaped like a bathtub). This simplifies the configuration of the oil pan separator, thereby reducing the cost of manufacturing the lubrication apparatus and the oil pan.

(2-13) As for the lubrication apparatus and the oil pan that are configured as described under (2-1) to (2-12) above, the oil communication path may be provided with a first valve that can open/close in accordance with the oil temperature in the first chamber.

When the configuration described above is employed, the first valve can be opened/closed in accordance with the operation of the lubrication target mechanism. This ensures that the interchange of the oil between the first chamber and the second chamber can be properly controlled in accordance with the operation of the lubrication target mechanism.

(2-14) As for the lubrication apparatus and the oil pan that are configured as described under (2-1) to (2-13) above, the second oil return path may be provided with a second valve that can open/close in accordance with the temperature of the return oil.

When the configuration described above is employed, the second valve can be opened/closed in accordance with the operation of the lubrication target mechanism. This ensures that the backflow of the return oil to the second chamber via the oil return path can be properly controlled in accordance with the operation of the lubrication target mechanism.

(2-15) The lubrication apparatus and the oil pan that are configured as described under (2-14) above may further comprise an open/close operation interlock section for ensuring that the open/close operation of the first valve and the open/close operation of the second valve are interlocked with each other.

In the configuration described above, the first valve can open/close in accordance with the operation of the lubrication target mechanism. Further, the open/close operation interlock section can interlock the open/close operation of the second valve with that of the first valve. This ensures that the oil interchange between the first chamber and the second chamber and the backflow of the return oil to the second chamber via the oil return path can be properly controlled in accordance with the operation of the lubrication target mechanism.

(2-16) As for the lubrication apparatus and the oil pan that are configured as described under (2-15) above, the open/close operation interlock section may be made of a wire member that is installed as a bridge between the first valve and the second valve.

In the configuration described above, the open/close operations of the first valve and the second valve can be interlocked with each other mechanically and properly via the wire member.

As described above, the present invention introduces the return oil, which flows back from the lubrication target mechanism, to the first and second chambers via the first and second oil return paths. Therefore, the return oil is stored in the second chamber as well. After termination of a warm-up operation, the return oil is stored in the second chamber so that the oil in the second chamber can be pushed toward the first chamber via the oil communication path. As a result, the entire oil in the oil pan, including the oil in the second chamber, can circulate between the oil pan and the lubrication target mechanism.

### BRIEF DESCRIPTION OF DRAWINGS

FIG. 1 is a schematic configuration of an engine that is equipped with an oil pan according to an embodiment of the present invention.

FIG. 2 is a cross-sectional view that schematically shows the configuration of an oil pan according to a first embodiment of the present invention that is included in the engine shown in FIG. 1.

FIG. 3 is a schematic configuration of an oil pan according to a second embodiment of the present invention that is included in the engine shown in FIG. 1.

FIG. 4 is an enlarged lateral cross-sectional view illustrating a thermostat valve apparatus that is shown in FIG. 3. FIG. 4(A) illustrates the thermostat valve apparatus that is closed at a low temperature. FIG. 4(B) illustrates the thermostat valve apparatus that is open at a high temperature.

FIG. 5 is a lateral cross-sectional view that schematically shows the configuration of an oil pan according to a third embodiment of the present invention that is included in the engine shown in FIG. 1.

FIG. 6 is a cross-sectional view that is taken along section C-C of FIG. 5.

FIG. 7 is a lateral cross-sectional view that schematically shows the configuration of an oil pan according to a fourth embodiment of the present invention that is included in the engine shown in FIG. 1.

FIG. 8 is a lateral cross-sectional view that schematically shows the configuration of an oil pan according to a fifth embodiment of the present invention that is included in the engine shown in FIG. 1.

FIG. 9 is a lateral cross-sectional view that schematically shows the configuration of an oil pan according to a sixth embodiment of the present invention that is included in the engine shown in FIG. 1.

FIG. 10 is a lateral cross-sectional view that schematically shows the configuration of an oil pan according to a seventh embodiment of the present invention that is included in the engine shown in FIG. 1.

FIG. 11 is an enlarged lateral cross-sectional view illustrating a return oil backflow valve apparatus that is shown in FIG. 10.

### BEST MODE FOR CARRYING OUT THE INVENTION

Embodiments of the present invention (embodiments that are considered to be the best by the applicant at the time of application of the present invention) will now be described with reference to the accompanying drawings.

### <Overview of Engine Configuration According to One Embodiment>

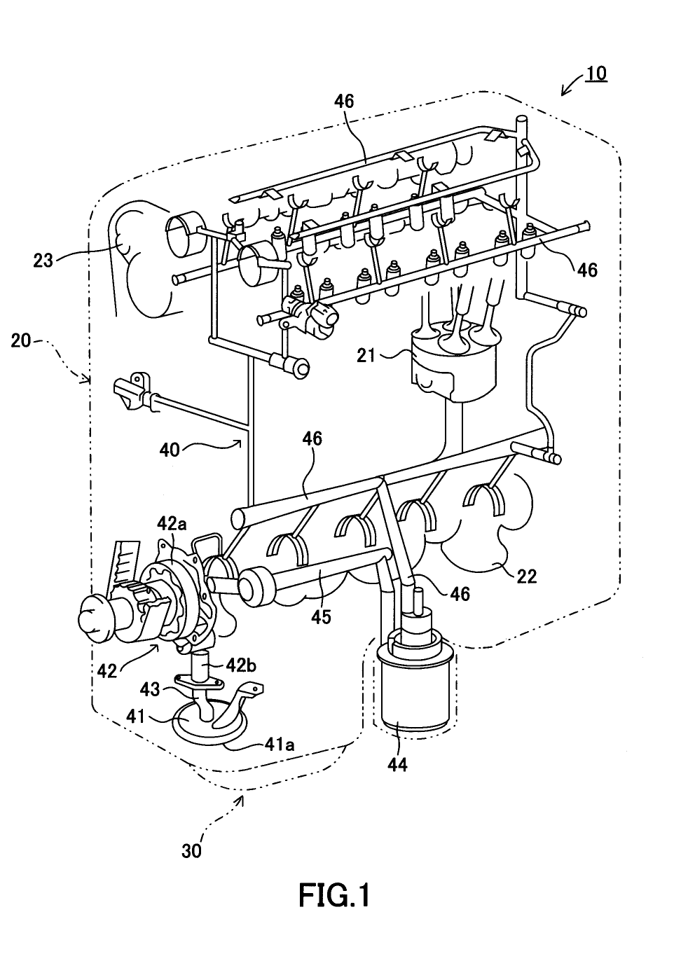

FIG. 1 schematically shows the configuration of an engine 10 in accordance with one embodiment of a lubrication apparatus according to the present invention. The engine includes a main body section (engine block) 20, which is a lubrication target mechanism that includes a cylinder head and a cylinder block; an oil pan 30 that is connected to the lower end of the engine block 20; and a lubrication system 40 for supplying oil stored in the oil pan 30 to internal parts of the engine 10.

The engine block 20 is provided with a plurality of lubrication target members such as a piston 21, a crankshaft 22, and a camshaft 23. The lower end of the engine block 20 is connected to the oil pan 30, which is capable of storing the oil for lubricating the interior of the engine block 20.

An oil strainer 41, which includes an intake port 41a for taking in the oil stored within the oil pan 30, is positioned inside the oil pan 30. The oil strainer 41 is connected by means of an oil pump 42 and a strainer flow path 43, which are provided in the engine block 20.

The oil pump 42 comprises a well-known rotary pump. Its rotor 42a is coupled to the crankshaft 22 so that the rotor 42a rotates together with the crankshaft 22. The strainer flow path 43 is made of a metallic pipe. Its lower end is connected to the oil strainer 41. The upper end of the strainer flow path 43 is connected to a pump inlet path 42b, which is an oil path formed at the lower end of the engine block 20. The oil pump 42 is connected via an oil transport path 45 to an oil filter 44, which is provided outside the engine block 20. The oil filter 44 is connected to an oil supply path 46, which is provided as an oil flow path toward the lubrication target members.

### <Oil Pan Configuration According to First Embodiment>

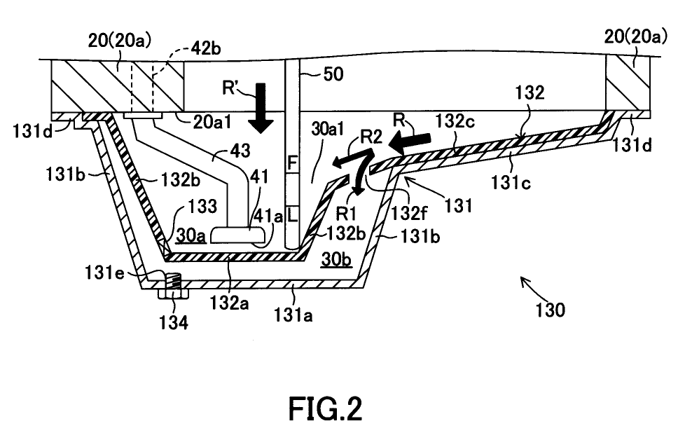

FIG. 2 is a lateral cross-sectional view illustrating the configuration of an oil pan 130 according to a first embodiment of the present invention that is included in the engine 10 shown in FIG. 1.

### <<Oil Pan Cover Configuration>>

An oil pan cover 131 is a bathtub-shaped member that constitutes an outer cover for the oil pan 130. It is formed by pressing a steel plate and constructed of one piece.

At a peripheral end of a bottom plate 131a of the oil pan cover 131, a side plate 131b is provided to enclose the bottom plate 131a. An opening is formed inside the side plate 131b in such a manner that it enlarges toward the engine block 20, which is positioned above (so that the area enclosed by the side plate 131b increases with an increase in the height).

A portion (the right-hand portion shown in FIG. 2) of the side plate 131b that is close to a power train mechanism (not shown) is coupled to a slope plate 131c. The slope plate 131c is less steep than the side plate 131b.

A flange section 131d is formed at a peripheral end of the oil pan cover 131. The flange section 131d is coupled to the side plate 131b and the slope plate 131c. The flange section 131d is to be mounted on a cylinder block 20a, which is in the lower section of the engine block 20. More specifically, the flange section 131d is bolted down or otherwise secured to a lower end face 20a1 of the cylinder block 20a.

The oil pan cover 131, which is configured as described above, is capable of storing oil within a space that is enclosed by the bottom plate 131a and the side plate 131b. A drain bolt hole 131e, which is a through-hole, is provided at the lowest position of the bottom plate 131a, which is located at the bottom of the space. (The term “lowest position” refers to the lowest position that prevails in the direction of gravity when a predefined apparatus (e.g., an automobile) containing the engine 10 is placed on level ground.) The drain bolt hole 131e is threaded so that a drain bolt 134 can be driven into it.

The oil pan cover 131 is shaped so that oil smoothly flows by gravity toward the drain bolt hole 131e via the surfaces of the bottom plate 131a, side plate 131b, and the slope plate 131c. In other words, when the drain bolt 134 is removed from the drain bolt hole 131e, the oil stored in the internal space of the oil pan cover 131 can entirely flow out of the oil pan 130 via the drain bolt hole 131e by gravity.

### <<Oil Pan Separator Configuration>>

The oil pan separator 132 is a plate-like member capable of storing oil inside. It is injection molded synthetic resin having a low thermal conductivity and constructed of one piece.

At a peripheral end of a bottom plate 132a of the oil pan separator 132, a side plate 132b is provided to enclose the bottom plate 132a. An opening is formed inside the side plate 132b in such a manner that it enlarges toward the engine block 20, which is positioned above. A portion (the right-hand portion shown in FIG. 2) of the side plate 132b that is close to a power train mechanism (not shown) is coupled to a slope plate 132c. The slope plate 132c is less steep than the side plate 132b.

The oil pan separator 132, which is configured as described above, is capable of storing oil in the internal space of a concave (first concave; hereinafter simply referred to as “the concave of the oil pan separator 132) that is formed by the bottom plate 132a, the side plate 132b, and the slope plate 132c. The concave of the oil pan separator 132 is open toward the cylinder block 20a and coupled to the internal space at the lower end of the cylinder block 20a. In other words, the return oil flowing back from the lubrication target members (e.g., the piston 21 and the crankshaft 22 shown in FIG. 1) positioned in the engine block 20, which is located above, can flow into the internal space of the concave of the oil pan separator 132 via the internal space at the lower end of the cylinder block 20a (see arrows R and R′ in FIG. 2).

The oil pan separator 132 is shaped so that oil can smoothly flow by gravity toward the bottom plate 132a on the side plate 132b and the slope plate 132c. In other words, the return oil is first received by the slope plate 132c. The received return oil can then smoothly flow downward into the space enclosed by the bottom plate 132a and the side plate 132b via the surface of the slope plate 132c (see arrow R in FIG. 2).

The inner bottom of the space enclosed by the bottom plate 132a and the side plate 132b is provided with the oil strainer 41. In other words, a first chamber 30a (first chamber formation concave) is formed by the space (abovementioned concave of the oil pan separator 132) enclosed by the bottom plate 132a and the side plate 132b of the oil pan separator 132. The substantial highest position of the first chamber 30a is provided by a joint between the side plate 132b and the slope plate 132c. The term “highest position” refers to the highest position that prevails in the direction of gravity when a predefined apparatus (e.g., an automobile) containing the engine 10 is placed on level ground. In other words, the substantial highest position of the first chamber 30a is a position corresponding to a first chamber opening 30a1, which is open upward to form an opening end of the first chamber 30a. The first chamber opening 30a1 is an opening that is formed at the upper end of the space that is enclosed by the bottom plate 132a and the side plate 132b of the oil pan separator 132 to constitute an important section of the first chamber 30a. The oil strainer 41 is positioned so that its intake port 41a is placed at a predetermined small distance (e.g., 10 mm or so) from the upper surface of the bottom plate 132a.

The oil pan separator 132 is positioned above the oil pan cover 131 (positioned upward in FIG. 2, that is, in a direction toward the cylinder block 20a). The verge of the oil pan separator 132 is supported by the flange section 131d of the oil pan cover 131. The outside of the slope plate 132c of the oil pan separator 132 (the side positioned away from the first chamber 30a) is partly superposed upon the slope plate 131c of the oil pan cover 131. The bottom plate 132a of the oil pan separator 132 is positioned a predetermined distance above the bottom plate 131a of the oil pan cover 131.

The oil pan separator 132 is supported inside the oil pan cover 131 so that the first chamber 30a is placed within the space enclosed by the bottom plate 131a and the side plate 131b of the oil pan cover 131. In other words, a second chamber 30b, which is provided by the space enclosed by the oil pan cover 131 and the oil pan separator 132, is formed below and laterally to the first chamber 30a (the highest position of the second chamber 30b is the position of a joint between the side plate 131b and the slope plate 131c).

The shape and dimensions of the oil pan separator 132 (particularly the shapes and dimensions of the bottom plate 132a and the side plate 132b) are set so that the first chamber 30a and the second chamber 30b are substantially equal in cubic capacity.

The slope plate 132c of the oil pan separator 132 is provided with a communication hole 132f that communicates with the second chamber 30b. The communication hole 132f is a through-hole having a circular opening that is approximately 10 to 20 mm in diameter when viewed from the top. One or more such through-holes are arranged in the perspectival direction (in a direction perpendicular to the paper surface of FIG. 2) of the engine 10 (see FIG. 1). The communication hole 132f, which serves as the oil return through-hole according to the present invention, provides communication between the upper sections of the first chamber 30a and the second chamber 30b, thereby permitting the return oil received by the upper section of the first chamber 30a to flow into the upper section of the second chamber 30b.

### <<Oil Circulation Flow Path Configuration in Oil Pan>>

In the oil pan 130 according to the present embodiment, the slope plate 132c having the communication hole 132f described above is such that part R1 of the return oil flow over the slope plate 132c, which is directed toward the first chamber 30a, goes into the second chamber 30b via the communication hole 132f with the remaining portion R2 going into the first chamber 30a. When the oil level in the second chamber 30b rises to reach the communication hole 132f, the amount of return oil R1 becomes zero so that the entire return oil flows into the first chamber 30a.

The communication hole 132f is roughly positioned flush with an “F (full)” oil level in the first chamber. The “F” oil level in the first chamber 30a corresponds to the height of an “F” mark on an oil level gauge 50, which measures the oil level in the first chamber 30a, when the oil level gauge 50 is mounted in the cylinder block 20a (the same also holds true for an “L (low)” oil level). The height that corresponds to the “F” mark on the oil level gauge 50 when the oil level gauge 50 is mounted in the engine 10 (see FIG. 1) is hereinafter simply referred to as the “F” oil level. Similarly, the height that corresponds to an “L” mark on the oil level gauge 50 when the oil level gauge 50 is mounted in the engine 10 (see FIG. 1) is hereinafter simply referred to as the “L” oil level.

For example, the “L” oil level can be set to a minimum oil level at which oil is properly taken in from the oil strainer 41 under severe operating conditions. More specifically, a pre-start minimum oil level can be set as the “L” oil level so that no air is taken in from the oil strainer 41 when the engine is started up at an extremely low temperature (e.g., approximately −30° C.).

The “F” oil level can be set to an oil level that is obtained by adding an appropriate amount of oil to the amount of oil stored at the “L” oil level described above. The oil pan 130 according to the present embodiment is set so that the amount of oil stored in the first chamber 30a is approximately 2.8 liters when the oil level in the first chamber 30a is “F,” and that the amount of oil stored in the first chamber 30a is approximately 1.6 liters when the oil level in the first chamber 30a is “L.” The height difference between the “F” and “L” oil levels is approximately 10 to 50 mm.

The oil pan 130 according to the present embodiment is configured so that approximately 30 to 50% of the opening at the lower end of the cylinder block 20a directly faces the first chamber 30a. Further, the oil pan 130 is configured so that the remaining portion of the opening faces the slope plate 132c. In other words, the slope plate 132c is dimensioned and shaped so that the flow amount ratio between return oil R, which is first received by the slope plate 132c and then allowed to flow downward over the slope plate 132c, and return oil R′, which directly flows into the first chamber 30a without being received by the slope plate 132c, approximately ranges from 5:5 to 7:3.

The shape, dimensions, and number of communication holes 132f are set so that the amount of return oil R1, which flows over the slope plate 132c and into the second chamber 30b, is substantially equal to the amount of return oil R2, which flows over the slope plate 132c and into the first chamber 30a. In other words, the slope plate 132c and the communication hole 132f are configured so that the total amount (R′+R2) of return oil flow to the first chamber 30a is larger than the total amount (R1) of return oil flow to the second chamber 30b ([R′+R2]:R1=7.5:2.5 to 6.5:3.5).

In the present embodiment, a first oil return path, which directs the return oil to the first chamber 30a, is formed by the opening at the lower end of the cylinder block 20a, which directly faces the first chamber 30a, and the downstream portion of the slope plate 132c (the portion close to the first chamber 30a) that has no communication hole 132f. In other words, the first oil return path according to the present invention is formed by the first chamber opening 30a1, which substantially constitutes the upper end of the first chamber 30a. The communication hole 132f constitutes a second oil return path, which directs the return oil to the second chamber 30b.

The bottom of the side plate 132b of the oil pan separator 132 is provided with a solenoid valve 133, which is mounted through the side plate 132b. The solenoid valve 133 opens/closes under control of an engine control circuit (not shown). More specifically, the engine control circuit controls the open/close operation of the solenoid valve 133 in accordance with the progress of a warm-up operation for the engine 10 (see FIG. 1), which is detected, for instance, on the basis of the cooling water temperature.

The solenoid valve 133 is normally open while it is not energized (while the engine is shut down). The oil pan 130 is configured so that the oil in the first chamber 30a can flow to the second chamber 30b via the solenoid valve 133 at the time of an oil change and be discharged to the outside from the second chamber 30b via the drain bolt hole 131e.

The solenoid valve 133 is positioned lower than the first chamber opening 30a1 through which the return oil passes when it returns to the first chamber 30a. Similarly, the solenoid valve 133 is positioned lower than the communication hole 132f through which the return oil passes when it returns to the second chamber 30b.

The solenoid valve 133 is mounted on the particular side plate 132b that faces the other side plate 132b which is connected to the slope plate 132c. In other words, the solenoid valve 133 is provided at the bottom of the first chamber 30a and positioned opposite the communication hole 132f (positioned farthest from the communication hole 132f). More specifically, the solenoid valve 133 is positioned opposite the communication hole 132f, which provides the path for returning the return oil to the second chamber 30b.

### <Operation of First Embodiment>

The operation performed by the engine 10, which is configured as described above, will now be described with reference to the accompanying drawings.

While the engine 10 is shut down, the solenoid valve 133 is open so that the oil levels in the first chamber 30a and the second chamber 30b are substantially equal. When the engine is cold started (this startup sequence involves a warm-up operation because an adequate amount of time has elapsed since the last engine shutdown), the solenoid valve 133 closes so as to start a warm-up operation for the engine 10.

When the engine 10 starts up, the oil pump 42 (see FIG. 1) operates so that a negative pressure is created at the intake port 41a of the oil strainer 41 in the first chamber 30a. The oil in the first chamber 30a is then taken in from the intake port 41a, and supplied to the lubrication target mechanism via the oil pump 42.

While a warm-up operation is being performed, the solenoid valve 133, which provides an oil communication path between the first chamber 30a and the second chamber 30b, is closed (the oil communication path is closed). Therefore, the oil level in the first chamber 30a lowers by approximately 10 mm immediately after startup. During a warm-up operation, the oil level in the first chamber 30a is lower than that in the second chamber 30b.

When a certain amount of time elapses after startup, the return oil flows back from the lubrication target mechanism to the oil pan 130 by gravity. As indicated in FIG. 2, the return oil is divided into return oil R and return oil R′. Return oil R is temporarily received by the slope plate 132c. Return oil R′ directly flows into the first chamber 30a without flowing over the slope plate 132c (flows into the first chamber 30a via the first chamber opening 30a1, which constitutes the aforementioned first oil return path).

In the oil pan 130 according to the present embodiment, the flow amount ratio between return oil R and return oil R′ ranges from approximately 5:5 to 7:3 (the actual flow amount ratio may vary with the operation). Substantially a half of return oil R flows into the second chamber 30b via the communication hole 132f as return oil R1. The remaining substantial half flows into the first chamber 30a on the slope plate 132c (via the first chamber opening 30a1, which constitutes the aforementioned first oil return path and without via the communication hole 132f) as return oil R2. Therefore, the ratio between the total amount of return oil flow to the first chamber 30a and the total amount of return oil flow to the second chamber ranges from 7.5:2.5 to 6.5:3.5. This ensures that a certain amount of relatively high-temperature return oil flows to the first chamber 30a. Consequently, the progress of a warm-up operation can be accelerated.

As mentioned earlier, the solenoid valve 133 is closed during a warm-up operation. Therefore, the oil supplied to the lubrication target members during a warm-up operation is virtually limited to the oil in the first chamber 30a. Therefore, the progress of a warm-up operation can be accelerated.

The second chamber 30b is positioned outside the first chamber 30a. The oil pan separator 132, which is made of synthetic resin, is sandwiched between the first chamber 30a and the second chamber 30b. Thus, the oil pan separator 132 and the second chamber 30b form a heat insulation layer between the first chamber 30a and outside air. Therefore, the oil temperature rise in the first chamber 30a (and in the lubrication target members) is accelerated. Consequently, the progress of a warm-up operation can be further accelerated.

Meanwhile, the oil in the first chamber 30a is continuously taken in by the oil pump 42 via the intake port 41a of the oil strainer 41 due to the progress of the warm-up operation. The return oil then continuously flows to the second chamber 30b. Consequently, when the warm-up operation progresses, the oil level difference between the first chamber 30a and the second chamber 30b gradually increases from a level (approximately 10 mm as mentioned earlier) prevailing immediately after startup.

When the warm-up operation terminates, the solenoid valve 133 opens (the oil communication path between the first chamber 30a and the second chamber 30b opens). At this moment, as mentioned above, the communication hole 132f is formed above the second chamber 30b, and the solenoid valve 133 is positioned at the bottom of the first chamber 30a (positioned lower than the first chamber opening 30a1 and the communication hole 132f). Therefore, the oil level in the second chamber 30b is increased due to the backflow of the return oil. Thus, a relatively great oil level difference arises between the second chamber 30b and the first chamber 30a whose oil level is lowered by startup.

Therefore, when the solenoid valve 133 opens, the oil in the second chamber 30b flows into the first chamber 30a due to a pressure difference between the first chamber 30a and the second chamber 30b, which is based on the oil level difference between the first chamber 30a and the second chamber 30b. Similarly, as return oil R1 flows to the second chamber 30b via the communication hole 132f after termination of a warm-up operation, the oil in the second chamber 30b flows into the first chamber 30a via the solenoid valve 133, which is positioned farthest from the communication hole 132f. This ensures that the oil vigorously circulates in the oil pan 130 after termination of a warm-up operation. Therefore, the entire oil in the oil pan 130 is used to lubricate the lubrication target members. Consequently, the engine 10 (see FIG. 1) is inhibited from overheating without degrading the durability of the oil.

### <Oil Pan Configuration According to Second Embodiment>

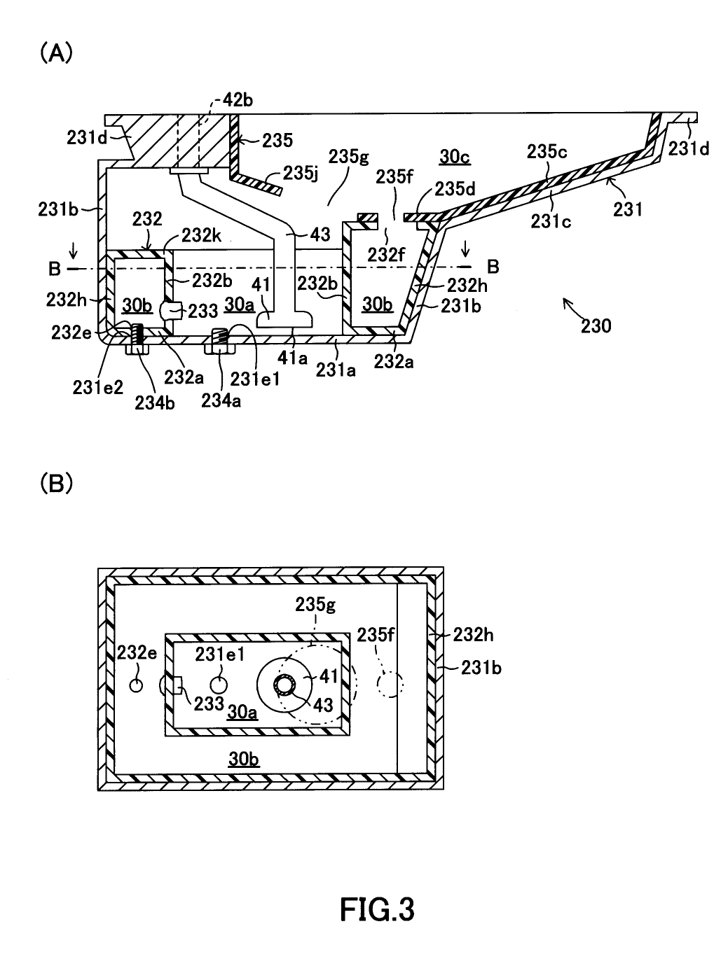

FIG. 3 are lateral cross-sectional views illustrating the configuration of an oil pan 230 according to a second embodiment of the present invention that is included in the engine 10 shown in FIG. 1. FIG. 3(A) is a lateral cross-sectional view. FIG. 3(B) is a cross-sectional view that is taken along section B-B of FIG. 3(A).

In the following description (including the description of the third and subsequent embodiments), elements commonly used in the first and subsequent embodiments are assigned the same reference numerals and may not be described repeatedly. Elements similar in operation and function to those of the oil pan 130 (see FIG. 2) according to the first embodiment are assigned reference numerals similar to those used in conjunction with the first embodiment (the same reference numeral digits are used except for the hundreds place). For example, an oil pan cover 231 according to the second embodiment corresponds to the oil pan cover 131 (see FIG. 2) according to the first embodiment.

In the oil pan 230 according to the present embodiment, an oil pan separator 232 is mounted on a bottom plate 231a of the oil pan cover 231. In other words, the oil pan separator 232 is positioned at the bottom of an internal space of the oil pan cover 231.

The oil pan cover 231 includes the bottom plate 231a, a side plate 231b, and a slope plate 231c, which are similar to the counterparts of the oil pan cover 131 (see FIG. 2) according to the first embodiment. A flange section 231d is provided with the pump inlet path 42b, which is an oil path that is connected to the upper end of the strainer flow path 43.

The oil pan separator 232 is made of a synthetic resin plate. It includes a bottom plate 232a, an inner wall 232b, an outer wall 232h, and a top plate 232k.

The inner wall 232b is a rectangular and tubular member whose lower end opening is in contact with the bottom plate 231a of the oil pan cover 231. The oil strainer 41 and the strainer flow path 43 are inserted down into an internal space of the rectangular tube of the inner wall 232b via the upper end opening of the inner wall 232b. In other words, the first chamber 30a is formed by the internal space (first concave to first chamber formation concave) of the rectangular tube of the inner wall 232b.

The outer wall 232h is a tubular member. It is in contact with (superposed on) the side plate 231b of the oil pan cover 231. The inner wall 232b is positioned in an internal space of the tube formed by the outer wall 232h. The bottom plate 232a is installed as a bridge between the lower ends of the inner wall 232b and the outer wall 232h. This bottom plate 232a is superposed on the bottom plate 231a of the oil pan cover 231. The top plate 232k is installed as a bridge between the upper ends of the inner wall 232b and the outer wall 232h.

In other words, the second chamber 30b is formed by a doughnut-shaped space that is enclosed by the bottom plate 232a, the inner wall 232b, the outer wall 232h, and the top plate 232k of the oil pan separator 232.

A portion (the right-hand portion shown in FIG. 3; hereinafter referred to as the first portion) of the oil pan separator 232 that is close to a power train mechanism (not shown) is provided with a through-hole 232f that is made in the top plate 232k. The first portion is positioned higher than the other portion (second portion). In other words, the through-hole 232f is positioned at an apex of the second chamber 30b. The first portion is positioned slightly higher (by several millimeters to 2 cm or so) than the “F” oil level in the first chamber 30a (the oil level gauge 50 shown in FIG. 2 is excluded from FIG. 3).

The bottom of the particular inner wall 232b that faces the other inner wall 232b which is closest to the power train mechanism is provided with a thermostat valve apparatus 233. In other words, the thermostat valve apparatus 233 is at the bottom of the first chamber 30a and positioned opposite the through-hole 232f (positioned farthest from the through-hole 232f).

The housing for the thermostat valve apparatus 233 contains a well-known wax-type thermostat valve, which is used, for instance, in an automobile cooling water circulation system. The thermostat valve apparatus 233 is configured so that when a predetermined valve opening temperature is reached, the interchange of oil occurs between the first chamber 30a and the second chamber 30b through the interior of the housing for the thermostat valve apparatus 233 (hereinafter simply referred to as “the interior of the thermostat valve apparatus 233”). Further, the thermostat valve apparatus 233 is also configured so that the valve opening ratio (the ratio of the current flow path cross-sectional area to the maximum flow path cross-sectional area within the interior of the thermostat valve apparatus 233) increases in accordance with a temperature rise.

In other words, an oil communication path between the first chamber 30a and the second chamber 30b is formed by the interior of the thermostat valve apparatus 233 (while the valve is open at a temperature not lower than the valve opening temperature). When the valve opening ratio is maximized (100%), the thermostat valve apparatus 233 has an oil passage cross-sectional area that is equivalent to the area of a circle having a radius of approximately 10 mm.

### <<Thermostat Valve Apparatus Configuration>>

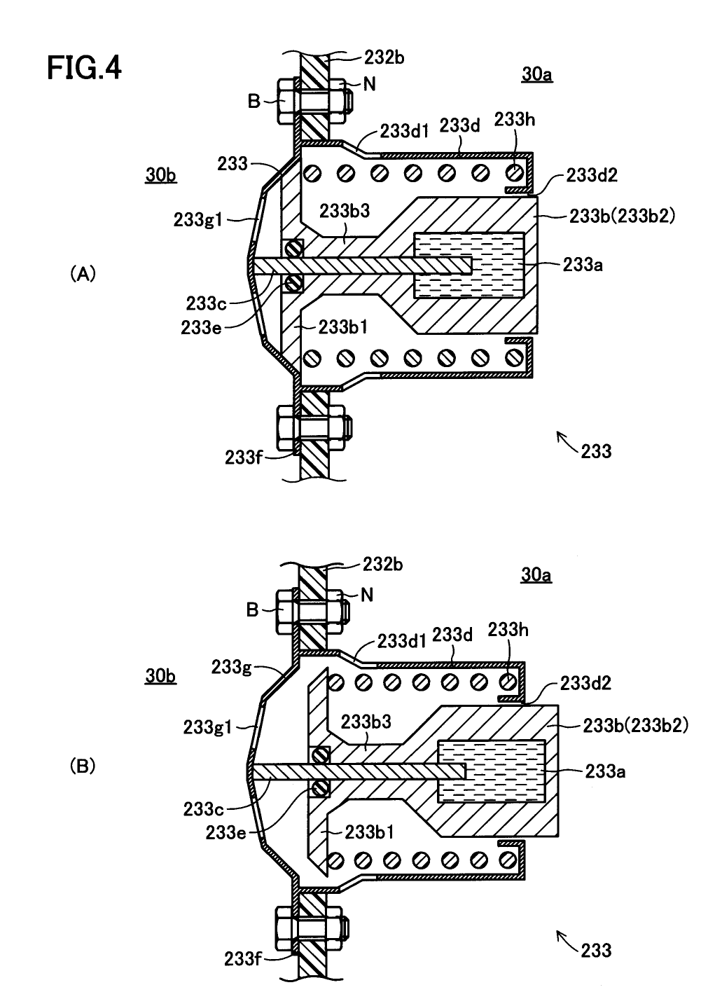

FIG. 4 are enlarged lateral cross-sectional views illustrating the thermostat valve apparatus 233 that is shown in FIG. 3. FIG. 4(A) illustrates the thermostat valve apparatus 233 that is closed at a low temperature. FIG. 4(B) illustrates the thermostat valve apparatus 233 that is open at a high temperature.

The thermostat valve apparatus 233 includes a metallic valve body 233b that is filled with wax 233a. The valve body 233b includes a valve disc 233b1, which has a through-hole at the center and is substantially shaped like a circular disc; a main body section 233b2, which is substantially shaped like a cylindrical column and provided with a cavity that is filled with wax 233a; and a connection section 233b3, which is substantially shaped like a cylinder and used to connect the valve disc 233b1 to the main body section 233b2. A rod 233c is positioned inside the cylinder that is formed by the connection section 233b3. One end of the rod 233c is exposed to the cavity filled with wax 233a, and the other end is exposed to the outside of the valve body 233b from the through-hole at the center of the valve disc 233b1.

The wax 233a, the valve body 233b, and the rod 233c are used to form a thermosensitive transformation section that can vary its shape in accordance with the oil temperature. The wax 233a, which constitutes a thermosensitive section of the thermosensitive transformation section, and the main body section 233b2, which is filled with the wax 233a, are enclosed by a housing 233d, which is a metallic member that is substantially shaped like a cylinder. The thermostat valve apparatus 233 is positioned in such a manner that the main body section 233b2 and the housing 233d are positioned toward the first chamber 30a. A sealant 233e is inserted into the through-hole in the valve disc 233b1 for sealing purposes so that the wax 233a, which is filled into the valve body 233b, does not leak out of the valve body 233b.

The housing 233d is provided with a first chamber side opening 233d1, which is a through-hole. The first chamber side opening 233d1 permits the internal space of the housing 233d to communicate with an external space (first chamber 30a). One end of the housing 233d is provided with a through-hole 233d2. The main body section 233b2 of the valve body 233b, which is filled with the wax 233a, is exposed to the first chamber 30a via the through-hole 233d2. Further, the main body section 233b2 of the valve body 233b can move (slide) inside this through-hole 233d2.

The other end of the housing 233d is provided with a flange section 233f, which is shaped like a circular disc and extended outward. When bolts B and nuts N are tightened with the flange section 233f superposed upon the inner wall 232b of the oil pan separator 232, the thermostat valve apparatus 233 is secured to the inner wall 232b.

The inside of the flange section 233f is connected to a second chamber facing cover 233g, which is made of a plated member that is exposed toward the second chamber 30b. The second chamber facing cover 233g is provided with a second chamber side opening 233g1, which is a through-hole. The other end of the rod 233c, which was mentioned earlier, is fastened to the second chamber facing cover 233g. The second chamber facing cover 233g (and the valve disc 233b1) are shaped so that the valve disc 233b1 cuts off the communication between the internal space of the housing 233d and the internal space of the second chamber facing cover 233g when the second chamber facing cover 233g comes into contact with the valve disc 233b1.

The internal space of the housing 233d is provided with a coil spring 233h that is positioned to surround the valve body 233b. One end of the coil spring 233h is in contact with the valve disc 233b1, and the other end is in contact with the aforementioned one end of the housing 233d.

### <<Drain Bolt Hole Configuration>>

Referring again to FIG. 3, the bottom plate 231a of the oil pan cover 231 is provided with drain bolt holes 231e1, 231e2, which are through-holes. The drain bolt hole 231e1 is provided at the lowest section of the first chamber 30a so that the oil stored in the first chamber 30a can leak out. The drain bolt hole 231e2 is formed so that the oil stored in the second chamber 30b leaks out. The bottom plate 232a of the oil pan separator 232 is provided with a drain hole 232e that communicates with drain bolt hole 231e2. The drain bolt holes 231e1 and 231e2 are threaded so that drain bolts 234a and 234b can be driven into them.

### <<Return Oil Guide Member Configuration>>

The top of the internal space of the oil pan cover 231 is provided with a return oil guide member 235. The return oil guide member 235 is a bathtub-shaped member that is capable of temporarily storing oil in it. It is injection molded synthetic resin having a low thermal conductivity and constructed of one piece. More specifically, the internal space of the return oil guide member 235 is provided with a return oil receiver 30c, which serves as a concave (second concave) for receiving the return oil. The detailed configuration of the return oil guide member 235 is described below.

The return oil guide member 235 includes a slope plate 235c, which is similar in configuration and function to the slope plate 132c (see FIG. 2) of the oil pan separator 132 according to the first embodiment; a bottom plate 235d, which is connected to the slope plate 235c; and a baffle plate 235j, which is connected to the bottom plate 235d.

The bottom plate 235d is joined to a section where the through-hole 232f is provided in the top plate 232k of the oil pan separator 232. The bottom of the bottom plate 235d is provided with at least one communication hole 235f that is similar in configuration and function to the communication hole 132f (see FIG. 2) according to the first embodiment. This communication hole 235f constitutes a second oil return path according to the present invention. The communication hole 235 communicates with the through-hole 232f. Part of the return oil captured by the return oil guide member 235 can flow into the second chamber 30b via the communication hole 235f and the through-hole 232f. The oil passage cross-sectional area of the communication hole 235f (or the total oil passage cross-sectional area if two or more communication holes 235f are provided) is larger than that of the thermostat valve apparatus 233.

The baffle plate 235j faces the first chamber 30a. The baffle plate 235j is positioned so as to temporarily impede the flow of the return oil (see arrow R′ in FIG. 2) that attempts to flow into the first chamber 30a without flowing over the slope plate 235c. The baffle plate 235j can inhibit, for instance, the flow of return oil R′ from bubbling or undulating the oil in the first chamber 30a.

The bottom of the baffle plate 235j is provided with a communication hole 235g that constitutes a first oil return path according to the present invention. The communication hole 235g is formed so that part of the return oil captured by the return oil guide member 235 (return oil receiver) can flow into the first chamber 30a via the communication hole 235g. The oil passage cross-sectional area of the communication hole 235g is larger than that of the aforementioned communication hole 235f. In other words, the return oil guide member 235 is configured so that the greater part (approximately 60 to 80%) of the return oil captured by the return oil guide member 235 flows to the first chamber 30a via the communication hole 235g.

When viewed from the top, the communication hole 235g is positioned close to the oil strainer 41 as indicated in FIG. 3(B). Therefore, the return oil that flows to the first chamber 30a via the communication hole 235g can be immediately taken in from the intake port 41a of the oil strainer 41.

Communication holes 235f and 235g are positioned higher than the thermostat valve apparatus 233. In other words, the thermostat valve apparatus 233 is positioned lower than communication holes 235f and 235g. Further, the thermostat valve apparatus 233 is at the bottom of the first chamber 30a and positioned opposite the communication hole 235f (positioned farthest from the communication hole 235f).

### <Operation of Second Embodiment>

While a warm-up operation is being performed, the oil temperature in the first chamber 30a is lower than the aforementioned valve opening temperature of the thermostat valve apparatus 233. Therefore, the thermostat valve apparatus 233, which constitutes the oil communication path between the first chamber 30a and the second chamber 30b, is closed (the aforementioned oil communication path is closed). More specifically, the communication between the first chamber 30a and the second chamber 30b breaks when the valve disc 233b1 comes into contact with the second chamber facing cover 233g as indicated in FIG. 4(A).

The warm-up operation terminates when the oil temperature in the first chamber 30a reaches the predetermined valve opening temperature. That is, the thermostat valve apparatus 233, which constitutes the oil communication path between the first chamber 30a and the second chamber 30b opens (the oil communication path between the first chamber 30a and the second chamber 30b opens). More specifically, the wax 233a melts to increase its cubic volume as indicated in FIG. 4(B) so that the aforementioned one end of the rod 233c is pushed out of the cavity filled with the wax 233a. The valve body 233b is then pushed toward the first chamber 30a against the pushing force of the coil spring 233h. This creates a gap between the second chamber facing cover 233g and the valve disc 233b1. Consequently, the oil communication path is formed between the first chamber side opening 233d1 and the second chamber side opening 233g1 via the gap within the housing 233d.

In the thermostat valve apparatus 233, the valve opening ratio (the ratio of the current flow path cross-sectional area to the maximum flow path cross-sectional area of the oil communication path) subsequently increases in accordance with a temperature rise. In other words, the valve body 233b is placed at a position at which the pushing force of the coil spring 233h balances with the force of the wax 233a that expands to push the valve body 233b toward the first chamber 30a in accordance with the first chamber oil temperature prevailing near the thermostat valve apparatus 233. Therefore, the interchange of oil in the oil communication path varies with the oil temperature.

The engine 10 (see FIG. 1) equipped with the oil pan 230 according to the second embodiment, which is configured as described above, operates in the same manner as the engine equipped with the oil pan 130 according to the first embodiment. Further, the engine 10 equipped with the oil pan 230 according to the second embodiment provides the following advantages.

In the oil pan 230 according to the present embodiment, the greater part of the return oil is temporarily received by the return oil receiver 30c, which is formed by the internal space of the return oil guide member 235, and then flows back to the first chamber 30a and the second chamber 30b via communication holes 235f and 235g, which are provided in the return oil guide member 235. Part of the return oil can directly flow back to the first chamber 30a and the second chamber 30b via communication holes 235f and 235g without being received by the return oil guide member 235.

At this moment, in the oil pan according to the present embodiment, the oil pan separator 232 is configured so that the first portion of the oil pan separator 232, in which the through-hole 232f for providing communication between the return oil receiver 30c and the second chamber 30b is provided, is positioned higher than the remaining second portion. The first portion is positioned slightly higher than the “F” oil level in the first chamber 30a. The through-hole 232f and the communication hole 235f for allowing the return oil to flow back to the second chamber 30b are formed at a position corresponding to an apex of the second chamber 30b, and positioned higher than the thermostat valve apparatus 233. This ensures that the oil level in the second chamber 30b can be higher than that in the first chamber 30a during a warm-up operation. Consequently, the pressure difference between the first chamber 30a and the second chamber 30b can be increased at the end of a warm-up operation.

Further, in the oil pan 230 according to the present embodiment, the thermostat valve apparatus 233 is at the bottom of the first chamber 30a and positioned opposite the through-hole 232f and the communication hole 235f. Therefore, the oil in the second chamber 30b flows into the first chamber 30a from the thermostat valve apparatus 233, which is positioned opposite a location (directly below the through-hole 232f and the communication hole 235f) where the oil level in the second chamber 30b rises due to the return of the return oil.

As a result, the configuration according to the present embodiment ensures that the oil vigorously circulates within the oil pan 230 after termination of a warm-up operation.

### <Oil Pan Configuration According to Third Embodiment>

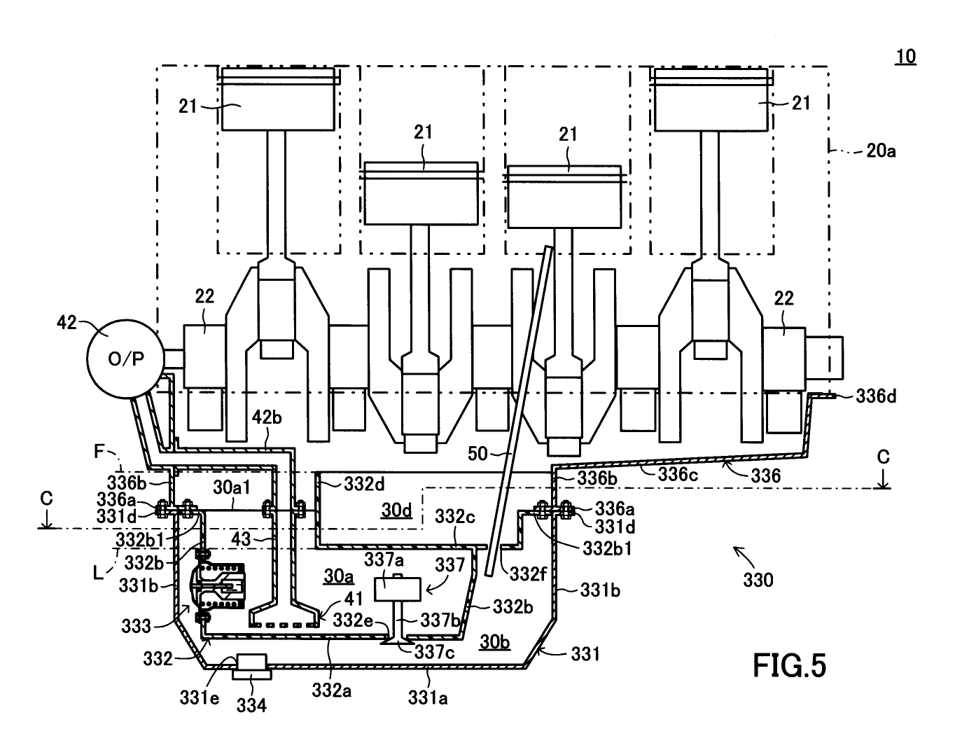

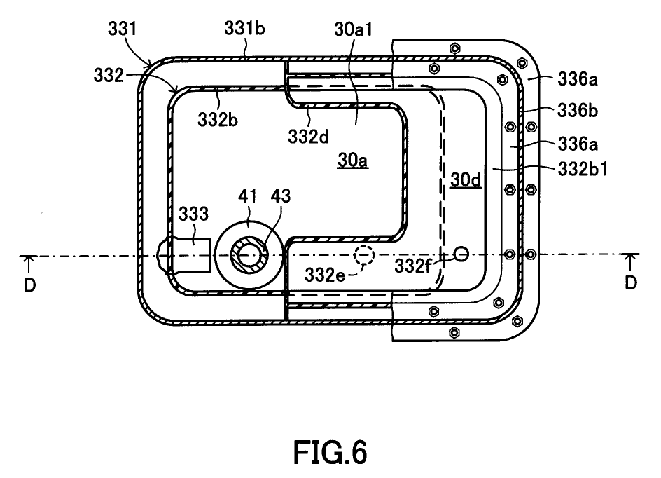

FIG. 5 is a lateral cross-sectional view illustrating the configuration of an oil pan 330 according to a third embodiment of the present invention that is included in the engine 10 shown in FIG. 1. FIG. 6 is a plane cross-sectional view illustrating the oil pan 330. FIG. 6 is a cross-sectional view that is taken along section C-C of FIG. 5. FIG. 5 is a cross-sectional view that is taken along section D-D of FIG. 6. The configuration of the oil pan 330 according to the present embodiment will now be described with reference to FIGS. 5 and 6.

The oil pan 330 according to the present embodiment includes an oil pan cover 331 that is made of a bathtub-shaped plate-like member and open toward the engine block 20 which is positioned above; an oil pan separator 332 that is positioned inside the oil pan cover 331; a thermostat valve apparatus 333 that is mounted on the oil pan separator 332; and a drain bolt 334 that is placed at the aforementioned lowest position of the oil pan cover 331.

### <<Oil Pan Cover Configuration>>

The oil pan cover 331 is a member that constitutes a lower cover for the oil pan 330. It is formed by pressing a steel plate and constructed of one piece.

At a peripheral end of a bottom plate 331a of the oil pan cover 331, a side plate 331b is provided to enclose the bottom plate 331a. The oil pan cover 331 is configured so that oil can be stored in a space that is enclosed by the bottom plate 331a and the side plate 331b. The lowest position of the bottom plate 331a, which is positioned at the bottom of the space, is provided with a drain bolt hole 331e. The drain bolt hole 331e is threaded so that the drain bolt 334 can be driven into it.

The oil pan cover 331 is shaped so that oil smoothly flows by gravity toward the drain bolt hole 331e on the bottom plate 331a and the side plate 331b. In other words, when the drain bolt 334 is removed from the drain bolt hole 331e, the oil stored in the internal space of the oil pan cover 331 can entirely flow out of the oil pan 330 via the drain bolt hole 331e by gravity.

A flange section 331d is formed at an upper end peripheral end of the side plate 331b of the oil pan cover 331. The flange section 331d is extended outward from the upper end of the side plate 331b. The flange section 331d can be joined to a flange section 336a that is formed at the lower end of a lower case 336, which is mounted in the cylinder block 20a. In other words, the lower case 336 is mounted on the lower end of the cylinder block 20a, and the oil pan cover 331 is secured to the flange section 336a formed at the lower end of the lower case 336.

The lower case 336 is positioned so as to cover the underside of the crankshaft 22, which is positioned at the lower end of the cylinder block 20a. The lower case 336 includes the aforementioned flange section 336a, a side plate 336b that is extended upward from the flange section 336a, a slope plate 336c that is extended from the upper end of the side plate 336b, and the aforementioned flange section 336d that is provided at the upper end of the lower case 336. The flange section 336d is extended outward. On the other hand, the flange section 336a is extended both outward and inward from the lower end of the side plate 336b. The flange section 331d of the oil pan cover 331 is fastened with bolts and nuts to the outer portion of the flange section 336a of the lower case 336.

The aforementioned slope plate 336c is coupled to a portion (the right-hand portion in FIG. 5) of the side plate 336b of the lower case 336 that is close to a power train mechanism (not shown). The gradient of the slope plate 336c is set so that the return oil received by the slope plate 336c can be supplied slowly toward the internal space of the oil pan cover 331.

### <<Oil Pan Separator Configuration>>

The oil pan separator 332 includes a bottom plate 332a, a side plate 332b, an upper partition plate 332c, and a lateral partition plate 332d. It is made of synthetic resin having a low thermal conductivity and constructed of one piece.

At a peripheral end of the bottom plate 332a of the oil pan separator 332, the side plate 332b is provided to enclose the bottom plate 332a. The first chamber 30a is substantially formed by a space (first concave or first chamber formation concave) that is enclosed by the bottom plate 332a and the side plate 332b. The second chamber 30b is formed by a space that is positioned below and laterally to the first chamber 30a and enclosed by the oil pan cover 331 and the oil pan separator 332.

The first chamber opening 30a1, which is positioned at the upper end of the side plate 332b and open toward the cylinder block 20a, is formed so that the return oil, which drops by gravity from the cylinder block 20a, passes and goes into the first chamber 30a. In other words, the first oil return path according to the present invention is provided by the first chamber opening 30a1. The height (the upper limit of the upward direction in the figure) of the first chamber 30a is such that the upper end of the lateral partition plate 332d, which will be described later, is reached.

The bottom of the side plate 332b of the oil pan separator 332 is provided with the thermostat valve apparatus 333. The thermostat valve apparatus 333 is configured the same as the thermostat valve apparatus 233 according to the second embodiment, which is described earlier (therefore, the description of the thermostat valve apparatus 233 according to the second embodiment (see FIG. 4) applies to the configuration of the thermostat valve apparatus 333 according to the present embodiment). The thermostat valve apparatus 333 is positioned lower than the “L” oil level. The oil strainer 41 is positioned at a small horizontal distance from the thermostat valve apparatus 333 but positioned lower than the thermostat valve apparatus 333.

A flange section 332b1 is extended outward from an upper end of the side plate 332b of the oil pan separator 332. This flange section 332b1 is fastened with bolts and nuts to the internal portion of the flange section 336a of the lower case 336 so that the oil pan separator 332 is supported by the internal space of the oil pan cover 331.

### <<Return Oil Storage Chamber>>

A return oil storage chamber 30d is formed above the first chamber 30a and the second chamber 30b, and positioned adjacent to the slope plate 336c of the lower case 336. The return oil storage chamber 30d is a space for storing the return oil that flows downward over the slope plate 336c. The return oil storage chamber 30d is provided by a space that is enclosed by the upper partition plate 332c and the lateral partition plate 332d, which are the parts of the oil pan separator 332, and the side plate 336b of the lower case 336. This space constitutes the return oil storage chamber 30d, which serves as the second concave according to the present invention. The detailed configuration of the return oil storage chamber 30d will now be described.

The upper partition plate 332c is a member that constitutes the bottom plate of the return oil storage chamber 30d. In other words, the upper partition plate 332c is positioned above the first chamber 30a and the second chamber 30b so as to provide a partition between the upper sections of the first chamber 30a and the second chamber 30b and the return oil storage chamber 30d. The upper partition plate 332c is connected to the upper end of a portion (the right-hand portion in FIG. 5; that is, a portion of the side plate 332b of the oil pan separator 332 that faces the mounting section of the thermostat valve apparatus 333) of the side plate 332b of the oil pan separator 332 that is close to the aforementioned power train mechanism (not shown).

The lateral partition plate 332d is a member that constitutes one end of the return oil storage chamber 30d in the longitudinal direction of the engine (in the longitudinal direction of the crankshaft 22). This lateral partition plate 332d is positioned to face the side plate 336b that constitutes the other end of the return oil storage chamber 30d in the longitudinal direction of the engine and is connected to the slope plate 336c.

The upper partition plate 332c is provided with a through-hole 332f that communicates with the upper section of the second chamber 30b. The through-hole 332f is configured so that the leading end of the oil level gauge 50 can be inserted into it. The through-hole 332f is shaped so that while the oil level gauge 50 is inserted in the through-hole 332f, a narrow gap having a predetermined width is formed between the oil level gauge 50 and the inner surface of the through-hole 332f. The term “narrow gap having a predetermined width” denotes a clearance that does not readily allow low-temperature, high-viscosity oil to pass through during a warm-up operation but readily allows low-viscosity oil to pass through at a relatively high temperature (e.g., 60° C. or so) that is close to the valve opening temperature of the thermostat valve apparatus 333.

That is, in the present embodiment, the second oil return path according to the present invention is formed by the aforementioned through-hole 332f. The through-hole 332f is placed at the position opposite the thermostat valve apparatus 333 that is positioned at one end of the first chamber 30a in the longitudinal direction (in the longitudinal direction of the crankshaft 22) of the engine. In other words, the through-hole 332f is positioned at a distance from the thermostat valve apparatus 333. More specifically, the through-hole 332f is placed at a position that is close to the other end of the first chamber 30a in the longitudinal direction of the engine.

Further, the through-hole 332f is formed so that an oil intake pipe, which is included in a commercially available oil changer that is configured to take in oil, can be set to discharge the entire oil from the oil pan 330. Furthermore, the through-hole 332f is formed so that an oil introduction pipe for introducing fresh oil into the oil pan 330 can be set.

In the present embodiment, the upper partition plate 332c and the through-hole 332f are positioned at a height that corresponds to the “L” oil level. In the present embodiment, the lateral partition plate 332d is configured so that its upper end is positioned at a height that corresponds to the “F” oil level.

The return oil storage chamber 30d is configured so that the backflow can override the upper end of the lateral partition plate 332d, which constitutes the upper end of the return oil storage chamber 30d, and go into the first chamber 30a via the first chamber opening 30a1.

The upper partition plate 332c and the lateral partition plate 332d are shaped as appropriate (in terms, for instance, of the planar shape of the upper partition plate 332c and the lateral partition plate 332d in FIG. 6 and the height of the lateral partition plate 332d in FIG. 5) so that oil properly circulates at all times in any operating state of the engine 10. In other words, the upper partition plate 332c and the lateral partition plate 332d are properly shaped (in terms, for instance, of the height and the presence of a slit and hole) so that an appropriate amount of the return oil (just like the amount described in conjunction with the aforementioned embodiments) directly flows back to the first chamber 30a via the first chamber opening 30a1, thereby sufficiently accelerating the warm-up operation while avoiding oil insufficiency in the first chamber 30a when the engine is started up at an extremely cold temperature. Further, the heights of the upper partition plate 332c and the lateral partition plate 332d are such that an appropriate amount of the return oil, which is stored in the return oil storage chamber 30d, flows into the second chamber 30b via the through-hole 332f, thereby invoking vigorous oil circulation between the second chamber 30b and the first chamber 30a.

More specifically, the oil pan 330 according to the present embodiment is configured so that approximately 30 to 60% of the opening at the lower end of the cylinder block 20a directly faces the first chamber 30a. In other words, the oil pan 330 according to the present embodiment is configured so that approximately 40 to 70% of the opening at the lower end of the cylinder block 20a faces the return oil storage chamber 30d and the slope plate 336c. The oil pan separator 332 is shaped as appropriate so that approximately 30 to 60% of the return oil directly flows back to the first chamber 30a while approximately 40 to 70% of the return oil is temporarily received by the return oil storage chamber 30d (part of the received return oil may flow over the lateral partition plate 332d and into the first chamber 30a).

### <<Float Valve Configuration>>

The bottom plate 332a of the oil pan separator 332 is provided with a drain hole 332e. The drain hole 332e is formed at the lowest position of the first chamber 30a. This drain hole 332e is large in diameter (e.g., approximately 20 mm in diameter) so that even a low-temperature (e.g., 0° C.), high-viscosity oil can flow out of the first chamber 30a (and toward the second chamber 30b). The drain hole 332e is provided with a float valve 337. The float valve 337 comprises a float 337a, a connection bar 337b, and a valve disc 337c.

The float 337a is positioned in the first chamber 30a and made of a material having a lower specific gravity than oil. The float 337a is mounted on one end of the connection bar 337b. The other end of the connection bar 337b is connected to the valve disc 337c. The valve disc 337c is positioned toward the second chamber 30b. The drain hole 332e is blocked up from below when the valve disc 337c comes into contact with the bottom plate 332a of the oil pan separator 332.

The float valve 337 is configured so that when the oil level in the first chamber 30a is higher than the central part in the height direction of the thermostat valve apparatus 333, the buoyant force of the float 337a presses the valve disc 337c upward, thereby causing the valve disc 337c to block up the drain hole 332e from below.

### <Operation of Third Embodiment>

The engine 10 having the oil pan 330 according to the third embodiment, which is configured as described above, operates in virtually the same manner as the engine having the oil pan 130 according to the first embodiment and the engine having the oil pan 230 according to the second embodiment. In addition, the engine 10 having the oil pan 330 according to the third embodiment provides effects particular to the third embodiment as described below.

When the engine 10 according to the present embodiment starts up, the crankshaft 22 rotates to operate the oil pump 42. The oil in the first chamber 30a is then pumped up via the oil strainer 41, which is provided at the bottom of the first chamber 30a, and then supplied to the members of the lubrication target mechanism such as the piston 21 and the crankshaft 22.

Immediately after a cold start (during a warm-up operation), the oil temperature in the first chamber 30a is lower than the aforementioned valve opening temperature of the thermostat valve apparatus 333. Therefore, the thermostat valve apparatus 333, which provides the oil communication path between the first chamber 30a and the second chamber 30b, is closed (the oil communication path is closed). Consequently, the oil level in the first chamber 30a decreases (e.g., by 10 mm or so) until it is lower than the oil level in the second chamber 30b.

When a certain amount of time elapses after startup, the return oil flows back by gravity from the lubrication target mechanism to the oil pan 330. Part of the return oil directly flows to the first chamber 30a via the first chamber opening 30a1. The return oil that directly flows back to the first chamber 30a raises the oil temperature in the first chamber 30a. Since the thermostat valve apparatus 333 is closed during a warm-up operation as described above, only the oil in the first chamber 30a is supplied to the lubrication target mechanism. As a result, the progress of the warm-up operation is accelerated.

The remaining portion of the return oil, which has not directly flowed to the first chamber 30a, is temporarily received by the return oil storage chamber 30d. More specifically, this return oil flows from the lubrication target mechanism to the return oil storage chamber 30d directly or via the slope plate 336c of the lower case 336. Before the return oil flowing into the return oil storage chamber 30d reaches a predetermined high temperature (e.g., 60° C. or so), the return oil does not readily pass through a narrow gap between the through-hole 332f and the oil level gauge 50. Therefore, the return oil is temporarily stored in the return oil storage chamber 30d.

When the oil temperature in the first chamber 30a reaches the predetermined valve opening temperature of the thermostat valve apparatus 333, the warm-up operation terminates. In other words, the thermostat valve apparatus 333, which provides the oil communication path between the first chamber 30a and the second chamber 30b, opens (the oil communication path between the first chamber 30a and the second chamber 30b opens). The negative pressure created in the oil strainer 41 then affects the oil communication path in the thermostat valve apparatus 333, which is formed near the oil strainer 41.

When the return oil stored in the return oil storage chamber 30d reaches the predetermined high temperature, the high-temperature return oil passes through a narrow gap between the through-hole 332f and the oil level gauge 50 and flows to the second chamber 30b. The oil is then supplied to the upper section of the second chamber 30b at a position opposite the thermostat valve apparatus 333 so that the oil level in the second chamber 30b temporarily rises. As the oil is supplied to the upper section of the second chamber 30b (the oil level in the second chamber 30b rises momentarily), the oil level difference between the second chamber 30b and the first chamber 30a from which the oil is constantly drawn via the oil strainer 41 increases. In other words, a hydraulic pressure difference arises near the thermostat valve apparatus 333 so that the oil flows from the second chamber 30b to the first chamber 30a.

The oil in the second chamber 30b then properly flows to the first chamber 30a via the oil communication path that is formed in the thermostat valve apparatus 333. Thus, an oil circulation path for moving the oil from the oil strainer 41 through the strainer flow path 43, oil pump 42, lubrication target mechanism, return oil storage chamber 30d, through-hole 332f, second chamber 30b, thermostat valve apparatus 333 to the first chamber 30a is formed. This oil circulation path allows the entire oil in the oil pan 330 to circulate properly.

In the thermostat valve apparatus 333, the valve opening ratio (the ratio of the current flow path cross-sectional area to the maximum flow path cross-sectional area of the oil communication path) subsequently increases in accordance with a temperature rise. The interchange of oil in the oil communication path then varies with the oil temperature.

In the oil pan 330 according to the present embodiment, the return oil storage chamber 30d is positioned to communicate with the upper section of the second chamber 30b via the through-hole 332f. Also, the return oil storage chamber 30d and the through-hole 332f are positioned higher than the thermostat valve apparatus 333. The oil level in the second chamber 30b can then be higher than that in the first chamber 30a during a warm-up operation. This ensures that the pressure difference between the first chamber 30a and the second chamber 30b can be increased at the end of a warm-up operation.

In the oil pan 330 according to the present embodiment, the thermostat valve apparatus 333 is at the bottom of the first chamber 30a and positioned opposite the through-hole 332f. Therefore, the oil in the second chamber 30b flows to the first chamber 30a through the thermostat valve apparatus 333, which is positioned away from a location where the second chamber oil level rises due to the backflow of the return oil. Consequently, the configuration according to the present embodiment ensures that oil circulation occurs in the oil pan 330 with increased vigorousness after termination of a warm-up operation.

In the oil pan 330 according to the present embodiment, the oil pan separator 332 (upper partition plate 332c) is provided with the through-hole 332f. When the leading end of the oil level gauge 50 is inserted into the through-hole 332f, the oil level gauge 50 is supported by the oil pan separator 332. Therefore, the employed configuration can properly support the oil level gauge 50 during an operation. The through-hole 332f is configured to accept the insertion of an oil changer's oil intake pipe or oil introduction pipe. Consequently, the employed configuration facilitates an oil change.

In the oil pan 330 according to the present embodiment, the drain hole 332e, which is formed at the lowest position of the first chamber 30a, is provided with the float valve 337. This ensures that even when the oil level in the first chamber 30a extremely lowers during a warm-up operation (e.g., when the oil level is lower than the central part in the height direction of the thermostat valve apparatus 333, that is, when the oil viscosity is extremely high immediately after the engine is started at an extremely low temperature), the float valve 337 moves downward to open the drain hole 332e, thereby supplying the oil in the second chamber 30b to the first chamber 30a via the drain hole 332e.

Meanwhile, when the amount of oil is sufficient (the oil level in the first chamber 30a is higher than the “L” oil level), the buoyant force of the float 337a moves the float valve 337 to the highest position within its movement range. The valve disc 337c is then pushed upward to block up the drain hole 332e from below. As a result, the drain hole 332e is properly blocked up during a warm-up operation.

When the entire oil is to be discharged out of the oil pan 330 for an oil change or the like (when the drain bolt 334 is removed from the drain bolt hole 331e or when the oil changer's oil intake pipe is inserted into the through-hole 332f with the oil level gauge 50 removed), the oil level in the first chamber 30a and/or second chamber 30b lowers to move the float valve 337 downward. The drain hole 332e, which is relatively large in diameter, then opens so that the entire oil can be immediately discharged out of the first chamber 30a.

### <Oil Pan Configuration According to Fourth Embodiment>

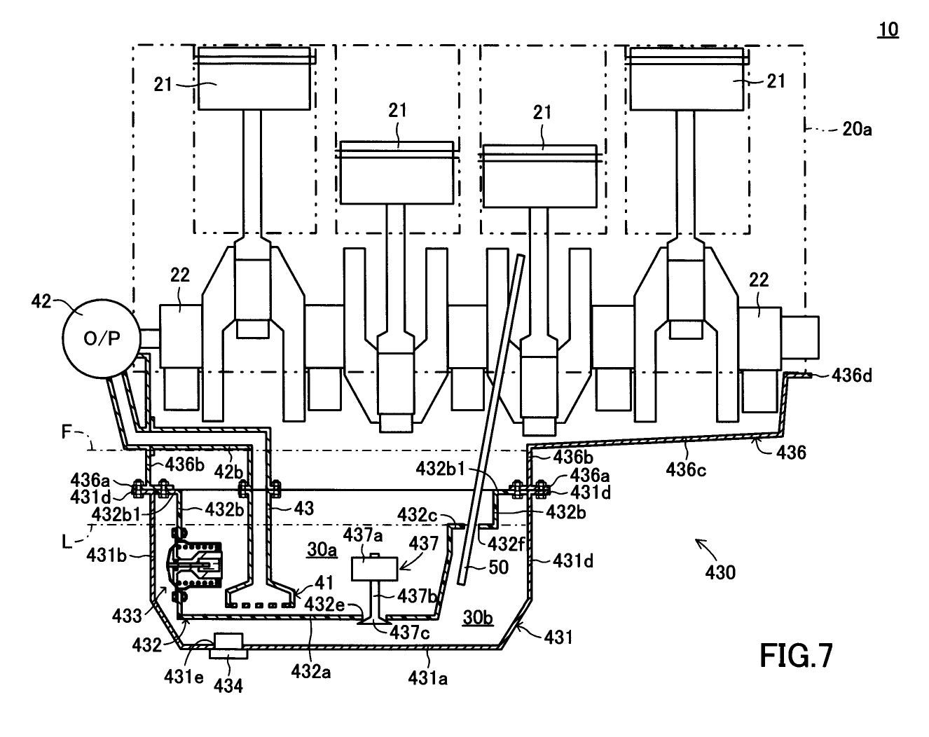

FIG. 7 is a lateral cross-sectional view illustrating the configuration of an oil pan 430 according to a fourth embodiment of the present invention that is included in the engine 10 shown in FIG. 1. The configuration of the oil pan 430 according to the present embodiment will now be described with reference to FIG. 7.

The oil pan 430 according to the present embodiment includes an oil pan cover 431 that is configured the same as the oil pan cover 331 (see FIG. 5) according to the third embodiment. More specifically, a bottom plate 431a, a side plate 431b, a flange section 431d, and a drain bolt hole 431e that constitute the oil pan cover 431 are configured the same as the bottom plate 331a, the side plate 331b, the flange section 331d, and the drain bolt hole 331e (see FIG. 5) that are described in conjunction with the third embodiment.

The thermostat valve apparatus 433 and the drain bolt 434 according to the present embodiment are configured the same as the thermostat valve apparatus 333 and the drain bolt 334 (see FIG. 5) according to the third embodiment.

The lower case 436 according to the present embodiment is configured the same as the lower case 336 (see FIG. 5) according to the third embodiment. More specifically, a flange section 436a, a side plate 436b, a slope plate 436c, and a flange section 436d that constitute the lower case 436 are configured the same as the flange section 336a, the side plate 336b, the slope plate 336c, and the flange section 336d (see FIG. 5) according to the third embodiment.

The float valve 437 according to the present embodiment is also configured the same as the float valve 337 (see FIG. 5) according to the third embodiment. More specifically, the float valve 437 comprises a float 437a, a connection bar 437b, and a valve disc 437c.

### <<Oil Pan Separator Configuration>>

The oil pan separator 432 according to the present embodiment is a bathtub-shaped member that comprises a bottom plate 432a and a side plate 432b. It is made of synthetic resin having a low thermal conductivity.

The bottom plate 432a is provided with a drain hole 432e that is the same as the counterpart of the third embodiment. At a peripheral end of the bottom plate 432a, the side plate 432b is provided to enclose the bottom plate 432a. The first chamber 30a is substantially formed by a space (first concave or first chamber formation concave) that is enclosed by the bottom plate 432a and the side plate 432b. As regards the height direction (upward in the figure), the first chamber 30a is formed to reach the height of a joint between the side plate 436b and the slope plate 436c of the lower case 436. The joint between the side plate 436b and the slope plate 436c of the lower case 436 is formed at a height that corresponds to the “F” oil level. The second chamber 30b is formed by a space that is positioned below and laterally to the first chamber 30a and enclosed by the oil pan cover 431 and the oil pan separator 432.

A flange section 432b1 is formed in such a manner that it extends outward from an upper end of the side plate 432b. As the flange section 432b1 is fastened with bolts and nuts to the inner portion of the flange section 436a of the lower case 436, the oil pan separator 432 is supported in an internal space of the oil pan cover 431.

A flat level gauge support 432c is formed on a portion of the side plate 432b that is close to the aforementioned power train mechanism (not shown). In other words, the gauge support 432c is formed on the right-hand portion of the side plate 432b in FIG. 7, that is, a portion of the side plate 432b of the oil pan separator 432 that faces an area in which the thermostat valve apparatus 433 is mounted. The level gauge support 432c, which supports the oil level gauge 50, is provided with an oil return through-hole 432f that establishes communication between the upper sections of the first chamber 30a and the second chamber 30b. The oil return through-hole 432f constitutes the second oil return path according to the present invention, and is configured the same as the through-hole 332f (see FIG. 5) according to the third embodiment.

More specifically, the configuration of the oil pan separator 432 according to the present embodiment differs from that of the oil pan separator 332 (see FIG. 5) according to the third embodiment in that the former excludes the return oil storage chamber 30d, the upper partition plate 332c, and the lateral partition plate 332d (see FIG. 5). The oil pan separator 432 according to the present embodiment is configured so that nearly all of the return oil flowing back through a cylindrical space (which corresponds to the first oil return path according to the present invention), which is enclosed by the side plate 436b of the lower case 436 and open toward the cylinder block 20a, first flows to the upper section of the first chamber 30a, and that part of the return oil in the upper section of the first chamber 30a can flow back into the second chamber 30b via the oil return through-hole 432f in accordance with a temperature rise of the return oil.

### <Operation of Fourth Embodiment>

When the engine 10 according to the present embodiment starts up, the crankshaft 22 rotates to operate the oil pump 42. The oil in the first chamber 30a is then supplied to the members of the lubrication target mechanism, such as the piston 21 and the crankshaft 22, via the oil strainer 41.

While a warm-up operation is being performed, the thermostat valve apparatus 433, which provides the oil communication path between the first chamber 30a and the second chamber 30b, is closed (the oil communication path is closed). Therefore, the oil level in the first chamber 30a decreases until it is lower than the oil level in the second chamber 30b.

When a certain amount of time elapses after startup, the return oil flows back by gravity from the lubrication target mechanism to the oil pan 430. The greater part of the return oil directly flows to the first chamber 30a via the first chamber opening 30a1. The return oil that directly flows back to the first chamber 30a raises the oil temperature in the first chamber 30a, thereby accelerating the progress of the warm-up operation.

When the oil in the first chamber 30a reaches a predetermined valve opening temperature of the thermostat valve apparatus 433, the thermostat valve apparatus 333, which constitutes the oil communication path between the first chamber 30a and the second chamber 30b, opens. Thereby the oil communication path between the first chamber 30a and the second chamber 30b is opened. The negative pressure created in the oil strainer 41 then affects the oil communication path in the thermostat valve apparatus 433, which is formed near the oil strainer 41.

When the return oil in the upper section of the first chamber 30a reaches a predetermined high temperature (e.g., 60° C. or so), the high-temperature return oil passes through a narrow gap between the oil return through-hole 432f and the oil level gauge 50 and flows into the second chamber 30b. The oil is then supplied to the upper section of the second chamber 30b at a position opposite the thermostat valve apparatus 433 so that the oil level in the second chamber 30b temporarily rises. As the oil is supplied to the upper section of the second chamber 30b (the oil level in the second chamber 30b rises momentarily), the oil level difference between the second chamber 30b and the first chamber 30a from which the oil is constantly drawn via the oil strainer 41 increases. In other words, a hydraulic pressure difference arises near the thermostat valve apparatus 433 so that the oil flows from the second chamber 30b to the first chamber 30a.

The oil in the second chamber 30b then flows into the first chamber 30a via the oil communication path that is formed in the thermostat valve apparatus 433. Thus, an oil circulation path for moving the oil from the oil strainer 41 through the strainer flow path 43, oil pump 42, lubrication target mechanism, oil return through-hole 432f, second chamber 30b, thermostat valve apparatus 433 to the first chamber 30a is formed. This oil circulation path allows the entire oil in the oil pan 430 to circulate properly.

In the oil pan 430 according to the present embodiment, the oil return through-hole 432f is positioned higher than the thermostat valve apparatus 433. This makes it possible to ensure that the oil level in the second chamber 30b is higher than that in the first chamber 30a during a warm-up operation. Consequently, the pressure difference between the first chamber 30a and the second chamber 30b can be increased at the end of a warm-up operation.

In the oil pan 430 according to the present embodiment, the thermostat valve apparatus 433 is at the bottom of the first chamber 30a and positioned opposite the oil return through-hole 432f. Therefore, the oil in the second chamber 30b flows to the first chamber 30a through the thermostat valve apparatus 433, which is positioned away from a location where the second chamber oil level rises due to the backflow of the return oil. Consequently, the configuration according to the present embodiment ensures that oil circulation occurs in the oil pan 430 with increased vigorousness after termination of a warm-up operation.

In the oil pan 430 according to the present embodiment, the oil return through-hole 432f can support the oil level gauge 50 and permit an oil change as is the case with the third embodiment.

In the oil pan 430 according to the present embodiment, the float valve 437 permits the oil in the second chamber 30b to be supplied to the first chamber 30a via the drain hole 432e as is the case with the third embodiment even when the oil level in the first chamber 30a extremely lowers, which is likely to occur, for instance, immediately after the engine is started up at an extremely low temperature. The float valve 437 also ensures that the drain hole 432e is properly blocked up during a warm-up operation. Further, when the entire oil is to be discharged out of the oil pan 330 for an oil change, the float valve 437 opens the drain hole 432e having a relatively large diameter so that the entire oil can be immediately discharged out of the first chamber 30a.

### <Oil Pan Configuration According to Fifth Embodiment>

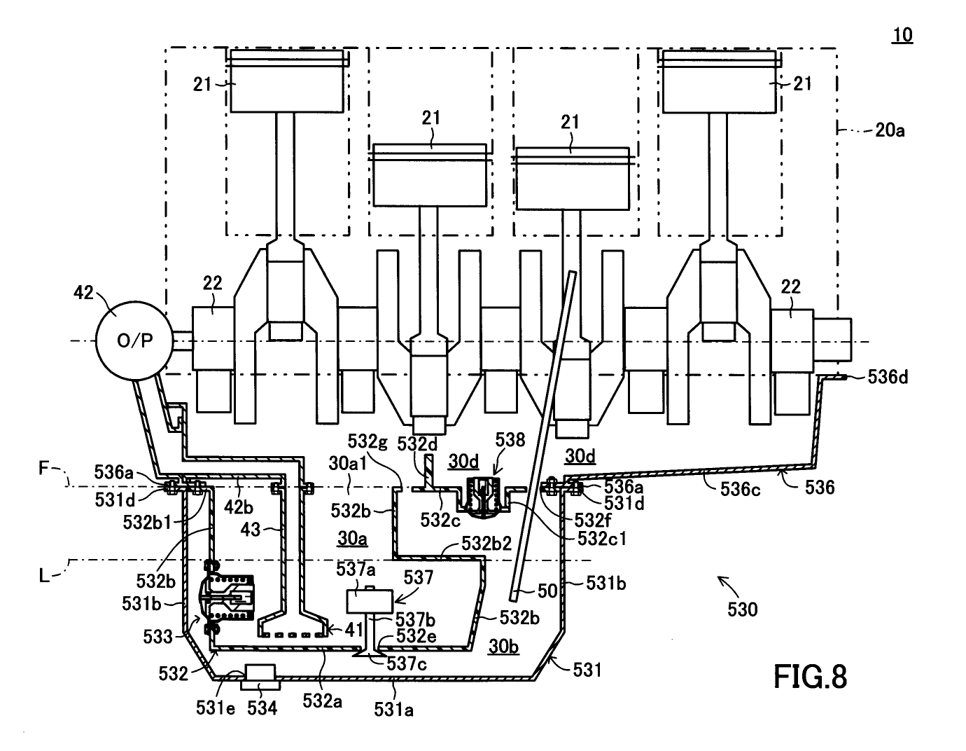

FIG. 8 is a lateral cross-sectional view illustrating the configuration of an oil pan 530 according to a fifth embodiment of the present invention that is included in the engine 10 shown in FIG. 1. The configuration of the oil pan 530 according to the present embodiment will now be described with reference to FIG. 8.

The oil pan 530 according to the present embodiment includes an oil pan cover 531 that is configured the same as the oil pan cover 331 (see FIG. 5) according to the third embodiment. More specifically, a bottom plate 531a, a side plate 531b, a flange section 531d, and a drain bolt hole 531e that constitute the oil pan cover 531 are configured the same as the bottom plate 331a, the side plate 331b, the flange section 331d, and the drain bolt hole 331e (see FIG. 5) that are described in conjunction with the third embodiment.

The first thermostat valve apparatus 533 and the drain bolt 534 according to the present embodiment are configured the same as the thermostat valve apparatus 333 and the drain bolt 334 (see FIG. 5) according to the third embodiment.

The lower case 536 according to the present embodiment is configured the same as the lower case 336 (see FIG. 5) according to the third embodiment. More specifically, a flange section 536a, a slope plate 536c, and a flange section 536d that constitute the lower case 536 are configured the same as the flange section 336a, the slope plate 336c, and the flange section 336d (see FIG. 5) that are described in conjunction with the third embodiment.

The float valve 537 according to the present embodiment is also configured the same as the abovementioned float valve 337 (see FIG. 5) according to the third embodiment. More specifically, the float valve 537 comprises a float 537a, a connection bar 537b, and a valve disc 537c.

### <<Oil Pan Separator Configuration>>

The oil pan separator 532 according to the present embodiment comprises a bottom plate 532a, a side plate 532b, an upper partition plate 532c, and a lateral partition plate 532d. It is made of synthetic resin having a low thermal conductivity.

The bottom plate 532a is provided with a drain hole 532e, which is the same as the counterpart of the third embodiment. At a peripheral end of the bottom plate 532a, the side plate 532b is provided to enclose the bottom plate 532a. The first chamber 30a is substantially formed by a space (first concave or first chamber formation concave) that is enclosed by the bottom plate 532a and the side plate 532b. The second chamber 30b is formed by a space that is positioned below and laterally to the first chamber 30a and enclosed by the oil pan cover 531 and the oil pan separator 532.

The upper end of the side plate 532b is positioned at a height that corresponds to the “F” oil level. The first chamber opening 30a1, which is positioned at the upper end of the side plate 532b and open toward the cylinder block 20a, is formed so that the return oil, which drops by gravity from the cylinder block 20a, can pass and go into the first chamber 30a. In other words, the first oil return path according to the present invention is provided by the first chamber opening 30a1.

A flange section 532b1 is formed in such a manner that it extends outward from an upper end of the side plate 532b. As the flange section 532b1 is fastened with bolts and nuts to the inner portion of the flange section 536a of the aforementioned lower case 536, the oil pan separator 532 is supported in an internal space of the oil pan cover 531.

A flat section 532b2 is formed on the middle portion of the side plate 532b that is close to the aforementioned power train mechanism (not shown). In other words, the flat section 532b2 is formed on the right-hand portion in FIG. 8, that is, a portion of the side plate 532b of the oil pan separator 532 that faces an area in which the thermostat valve apparatus 533 is mounted. The flat section 532b2 extends inward (toward the first chamber 30a). This flat section 532b2 is positioned at a height that corresponds to the “L” oil level. In other words, the flat section 532b2 is formed so that the bottom of the first chamber 30a (the portion lower than the “L” oil level) bulges toward the second chamber 30b to provide the bottom of the first chamber 30a with an adequate oil accommodation cubic volume.

The upper partition plate 532c, which is a plate-like member for defining the upper limit of the second chamber 30b, is placed substantially in a horizontal manner above the flat section 532b2. The upper partition plate 532c is connected to the upper end of the side plate 532b, which is connected to the inner end of the flat section 532b2. As is the case with the aforementioned flange section 532b1, the end of the upper partition plate 532c that is close to the aforementioned power train mechanism is fastened with bolts and nuts to the inner portion of the flange section 536a of the lower case 536.

The lateral partition plate 532d is extended upward from the upper partition plate 532c. The space formed by the lateral partition plate 532d and the upper partition plate 532c constitutes the return oil storage chamber 30d, which serves as the second concave according to the present invention. The return oil storage chamber 30d is formed so as to temporarily store the return oil that flows back by gravity from a portion of the cylinder block 20a that is close to the aforementioned power train mechanism (not shown). The upper partition plate 532c is positioned to provide a partition between the return oil storage chamber 30d and the upper section of the second chamber 30b.

The end of the upper partition plate 532c that is close to the aforementioned power train mechanism (close to the inner flange section 536a of the lower case 536) is provided with an oil return through-hole 532f. The oil return through-hole 532f is configured the same as the through-hole 332f (see FIG. 5) according to the third embodiment and the oil return through-hole 432f (see FIG. 7) according to the fourth embodiment. As shown in FIG. 8, the oil return through-hole 532f is formed at the aforementioned highest position of the second chamber 30b.

A portion of the upper partition plate 532c that is positioned outside the return oil storage chamber 30d (outside the lateral partition plate 532d) is provided with a through-hole 532g. The through-hole 532g communicates with the second chamber 30b. The through-hole 532g is formed so that the return oil, which spills out of the return oil storage chamber 30d after being temporarily received by the return oil storage chamber 30d that is provided by the upper partition plate 532c, can flow back to the second chamber 30b.

A portion of the upper partition plate 532c that is positioned inside the return oil storage chamber 30d is provided with a second thermostat valve apparatus 538, which penetrates through the upper partition plate 532c. The second thermostat valve apparatus 538 is configured the same as the first thermostat valve apparatus 533. More specifically, the second thermostat valve apparatus 538 is configured so as to open when the return oil temporarily stored in the return oil chamber 30d reaches a predetermined high temperature (e.g., 60° C.), thereby allowing the return oil to rush into the second chamber 30b.

In the present embodiment, the second thermostat valve apparatus 538 is configured to open later than the first thermostat valve apparatus 533. Further, the second thermostat valve apparatus 538 is placed at the lowest position of the upper partition plate 532c. In other words, the upper partition plate 532c is provided with a thermostat mounting concave 532c1, which protrudes downward. The second thermostat valve apparatus 538 is positioned to penetrate through the bottom of the thermostat mounting concave 532c1.

In the present embodiment, the oil return through-hole 532f, the through-hole 532g, and the second thermostat valve apparatus 538 constitute the second oil return path and (second) communication hole according to the present invention as described above.

The oil pan 530 according to the present embodiment is configured so that approximately 50 to 70% of the opening at the lower end of the cylinder block 20a faces the return oil storage chamber 30d and the slope plate 536c. In other words, the oil pan separator 532 is shaped as appropriate (in terms of the shape of the first chamber opening 30a1 and the shape and position of the lateral partition plate 532d) so that approximately 50 to 70% of the return oil is temporarily received by the return oil storage chamber 30d (part of the received return oil may flow over the lateral partition plate 532d and into the first chamber 30a or second chamber 30b).

In other words, the amount of return oil stored in the return oil storage chamber 30d depends on the dimensions and shape (height in particular) of the lateral partition plate 532d. In the present embodiment, therefore, the lateral partition plate 532d is dimensioned and shaped as appropriate to store a proper amount of return oil for circulating the oil properly in the engine block 20 and the oil pan 530 in every operating state of the engine 10.

More specifically, the lateral partition plate 532d has a sufficient height so that when the second thermostat valve apparatus 538 opens, a relatively large amount of return oil flows to the second chamber 30b, allowing the oil to circulate in the oil pan 530 (circulate between the first chamber 30a and the second chamber 30b) with increased vigorousness after termination of a warm-up operation.

Meanwhile, the height of the lateral partition plate 532d is limited to ensure that the amount of oil in the first chamber 30a is sufficient at a cold start (particularly when the engine is started up at an extremely low temperature). The height of the lateral partition plate 532d is also limited to ensure that an appropriate amount of return oil flows back to the first chamber 30a during a warm-up operation, thereby accelerating the progress of a warm-up operation.

### <Operation of Fifth Embodiment>

When the engine 10 according to the present embodiment starts up, the crankshaft 22 rotates to operate the oil pump 42. The oil in the first chamber 30a is then supplied to the members of the lubrication target mechanism, such as the piston 21 and the crankshaft 22, via the oil strainer 41.

While a warm-up operation is being performed, the first thermostat valve apparatus 533, which provides the oil communication path between the first chamber 30a and the second chamber 30b, is closed (the oil communication path is closed). Therefore, the oil level in the first chamber 30a decreases until it is lower than the oil level in the second chamber 30b.

When a certain amount of time elapses after startup, the return oil flows back by gravity from the lubrication target mechanism to the oil pan 530. Part of the return oil directly flows to the first chamber 30a via the first chamber opening 30a1. The return oil that directly flows back to the first chamber 30a raises the oil temperature in the first chamber 30a, thereby accelerating the progress of the warm-up operation.

The remaining portion of the return oil, which has not directly flowed to the first chamber 30a, is temporarily received by the return oil storage chamber 30d. More specifically, this return oil flows from the lubrication target mechanism to the return oil storage chamber 30d directly or via the slope plate 536c of the lower case 536. Before the return oil flowing into the return oil storage chamber 30d reaches a predetermined high temperature (e.g., 60° C. or so), the second thermostat valve apparatus 538 is closed. In this instance, therefore, the return oil is temporarily stored in the return oil storage chamber 30d.

Before the second thermostat valve apparatus 538 opens, the return oil spilling out of the return oil storage chamber 30d may flow over the lateral partition plate 532d and move toward the upper partition plate 532c, which is positioned outside the return oil storage chamber 30d. The spilt return oil flows back into the first chamber 30a via the first chamber opening 30a1 or flows back into the second chamber 30b via the through-hole 532g. Therefore, part of the return oil flows back into the second chamber 30b even before the second thermostat valve apparatus 538 opens. This ensures that the oil level difference between the first chamber 30a and the second chamber 30b that prevails during a warm-up operation and before the opening of the second thermostat valve apparatus 538 can be greater than the oil level difference between the first chamber 30a and the second chamber 30b that prevails immediately after startup.

When the oil in the first chamber 30a reaches a predetermined valve opening temperature of the first thermostat valve apparatus 533, the warm-up operation terminates. In other words, the first thermostat valve apparatus 533, which provides the oil communication path between the first chamber 30a and the second chamber 30b, opens (the oil communication path between the first chamber 30a and the second chamber 30b opens). The negative pressure created in the oil strainer 41 and the differential pressure based on the oil level difference between the first chamber 30a and the second chamber 30b then affect the oil communication path in the first thermostat valve apparatus 533, which is formed near the oil strainer 41. Consequently, the oil in the second chamber 30b flows into the first chamber 30a via the oil communication path that is formed in the first thermostat valve apparatus 533.

When the return oil stored in the return oil storage chamber 30d reaches the predetermined high temperature, the second thermostat valve apparatus 538 opens. A relatively large amount of return oil stored in the return oil storage chamber 30d then rushes into the second chamber 30b via the second thermostat valve apparatus 538. This causes the oil to be supplied to the upper section of the second chamber 30b at a position opposite the first thermostat valve apparatus 533 so that the oil level in the second chamber 30b temporarily rises. As the oil is supplied to the upper section of the second chamber 30b (the oil level in the second chamber 30b rises momentarily), the oil level difference between the second chamber 30b and the first chamber 30a from which the oil is constantly drawn via the oil strainer 41 increases. In other words, a hydraulic pressure difference arises near the first thermostat valve apparatus 533 so that the oil flows from the second chamber 30b to the first chamber 30a.

The oil in the second chamber 30b then vigorously flows into the first chamber 30a via the oil communication path that is formed in the first thermostat valve apparatus 533. Therefore, the entire oil circulates in the oil pan 530 with increased efficiency.

In the oil pan 530 according to the present embodiment, the oil return through-hole 532f, the through-hole 532g, and the second thermostat valve apparatus 538, which constitute the second oil return path according to the present invention, are positioned higher than the first thermostat valve apparatus 533. This makes it possible to ensure that the oil level in the second chamber 30b is higher than that in the first chamber 30a during a warm-up operation. Consequently, the pressure difference between the first chamber 30a and the second chamber 30b can be increased at the end of a warm-up operation.

In the oil pan 530 according to the present embodiment, the first thermostat valve apparatus 533 is at the bottom of the first chamber 30a and positioned opposite the second oil return path. Therefore, the oil in the second chamber 30b flows to the first chamber 30a through the first thermostat valve apparatus 533, which is positioned away from a location where the second chamber oil level rises due to the backflow of the return oil. Consequently, the configuration according to the present embodiment ensures that oil circulation occurs in the oil pan 530 with increased vigorousness after termination of a warm-up operation.

In the oil pan 530 according to the present embodiment, the float valve 537 permits the oil in the second chamber 30b to be supplied to the first chamber 30a via the drain hole 532e as is the case with the third and fourth embodiments even when the oil level in the first chamber 30a extremely lowers, which is likely to occur, for instance, immediately after the engine is started up at an extremely low temperature. The float valve 537 also ensures that the drain hole 532e is properly blocked up during a warm-up operation. Further, when the entire oil is to be discharged out of the oil pan 330 for an oil change, the float valve 537 opens the drain hole 532e having a relatively large diameter so that the entire oil can be immediately discharged out of the first chamber 30a.

In the oil pan 530 according to the present embodiment, the oil return through-hole 532f can support the oil level gauge 50 and permit an oil change as is the case with the third and fourth embodiments.

When fresh oil is introduced into the oil pan 530 according to the present embodiment, the air in the second chamber 30b is driven upward via the oil return through-hole 532f. In other words, the oil return through-hole 532f functions as an air-bleeding hole for driving air out of the second chamber 30b. In the present embodiment, the oil return through-hole 532f is formed at the aforementioned highest position of the second chamber 30b. Therefore, when fresh oil is introduced into the oil pan 530, air is properly driven out of the upper section of the second chamber 30b. Consequently, a specified amount of oil can be properly introduced into the oil pan 530.

### Sixth Embodiment

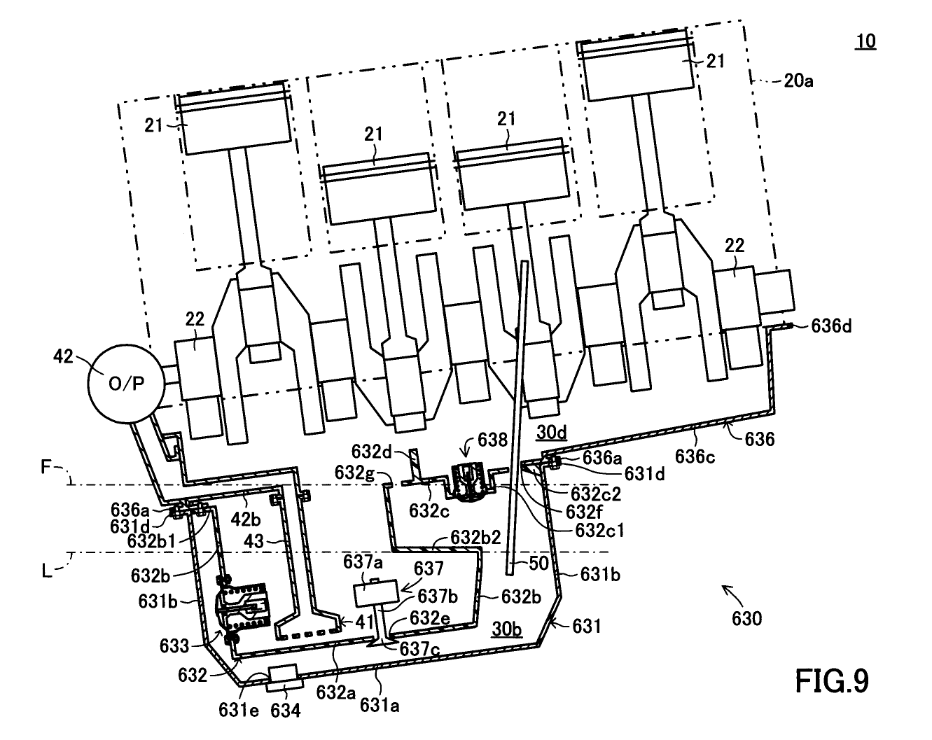

FIG. 9 is a lateral cross-sectional view illustrating the configuration of an oil pan 330 according to a sixth embodiment of the present invention that is included in the engine 10 shown in FIG. 1. The configuration of the sixth embodiment is virtually the same as that of the fifth embodiment. Almost all elements of the oil pan 630 according to the present embodiment are assigned the same reference numerals (same two lowest digits) as those of the oil pan 530 (see FIG. 8) according to the fifth embodiment. Therefore, the description of the fifth embodiment can be applied to various elements of the oil pan 630 according to the present embodiment.

However, the engine 10 according to the present embodiment is inclined at a predetermined angle to the vehicle as shown in FIG. 9. Therefore, when the vehicle is placed on level ground, the engine 10 is positioned at the predetermined angle to the horizontal.

The oil pan 630 according to the present embodiment is formed so that the flat section 632b2 of the side plate 632b of the oil pan separator 632 is parallel to the horizontal when the oil pan 630 is mounted on the vehicle.

In the oil pan 630 according to the present embodiment, an air guide section 632c2 is formed at the aforementioned highest position of the upper partition plate 632c. The air guide section 632c2 is gradually thicker (in a wedge form) from the end of the oil return through-hole 632f toward the end close to the aforementioned power train mechanism (not shown). The underside of the air guide section 632c2 is inclined upward from the end close to the power train mechanism to the end toward the oil return through-hole 632f.

As the upper end of the second chamber 30b is filled by the air guide section 632c2, the oil pan 630 according to the present embodiment is configured so that the oil return through-hole 632f, which functions as an air-bleeding hole as is the case with the fifth embodiment, is placed at a position corresponding to the highest position of the second chamber 30b.

When the configuration described above is employed, the air in the upper section of the second chamber 30b is directed upward by the underside of the upper partition plate 632c, which includes the underside of the air guide section 632c2. Thus, the air is properly discharged from the upper section of the second chamber 30b via the oil return through-hole 632f. Therefore, when the oil is to be changed (fresh oil is to be introduced), it is possible to prevent air from remaining in the upper section of the second chamber 30b and blocking the introduction of oil the amount of which is equal to the amount of air remaining in the upper section of the second chamber 30b.

### <Oil Pan Configuration According to Seventh Embodiment>

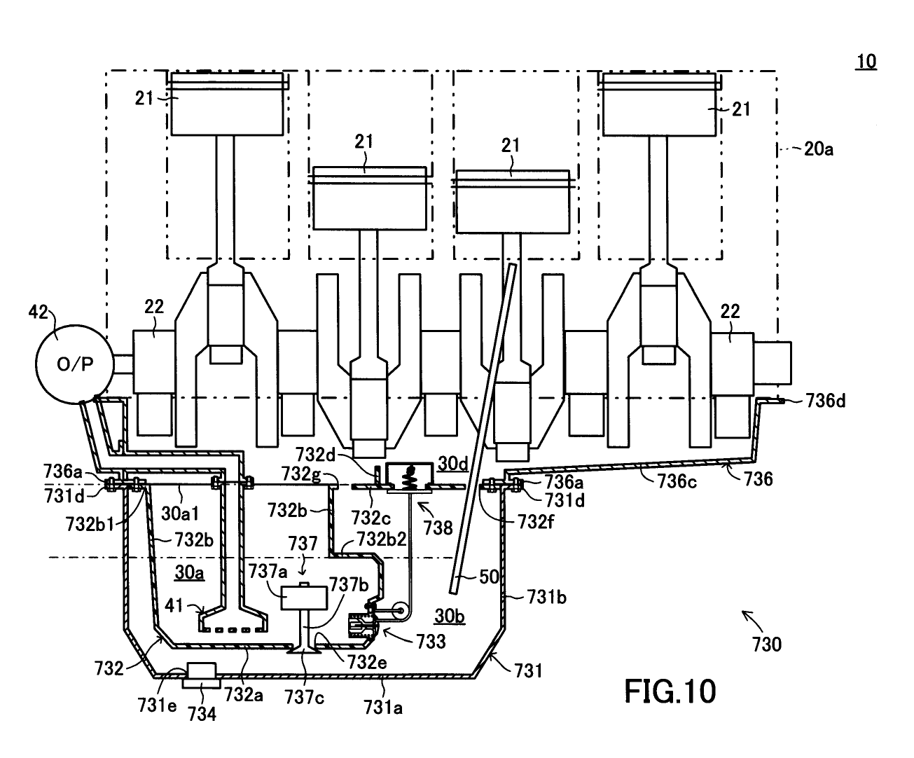

FIG. 10 is a lateral cross-sectional view illustrating the configuration of an oil pan 730 according to a seventh embodiment of the present invention that is included in the engine 10 shown in FIG. 1.

The oil pan 730 according to the present embodiment includes an oil pan cover 731, which is configured the same as the oil pan cover 531 (see FIG. 8) according to the fifth embodiment. More specifically, a bottom plate 731a, a side plate 731b, a flange section 731d, and a drain bolt hole 731e that constitute the oil pan cover 731 are configured the same as the bottom plate 531a, the side plate 531b, the flange section 531d, and the drain bolt hole 531e (see FIG. 8) that are described in conjunction with the fifth embodiment. Thus, the bottom plate 731a and other members configured the same as the counterparts according to the fifth embodiment are assigned the same reference numerals (same two lowest digits) as those of the oil pan 530 (see FIG. 8) according to the fifth embodiment. Therefore, the description of the fifth embodiment can be applied to various elements according to the present embodiment.

The thermostat valve apparatus 733 according to the present embodiment is configured the same as the first thermostat valve apparatus 533 (see FIG. 8) according to the fifth embodiment.

The drain bolt 734 according to the present embodiment is configured the same as the drain bolt 534 (see FIG. 8) according to the fifth embodiment and can be removed from the drain bolt hole 731e in the oil pan cover 731.

The lower case 736 according to the present embodiment is configured the same as the lower case 536 (see FIG. 8) according to the fifth embodiment. More specifically, a flange section 736a, a slope plate 736c, and a flange section 736d that constitute the lower case 736 are configured the same as the flange section 536a, the slope plate 536c, and the flange section 536d (see FIG. 8) that are described in conjunction with the fifth embodiment.

The float valve 737 according to the present embodiment is configured the same as the abovementioned float valve 537 (see FIG. 8) according to the fifth embodiment, and comprises a float 737a, a connection bar 737b, and a valve disc 737c.

### <<Oil Pan Separator Configuration>>

The oil pan separator 732 according to the present embodiment comprises a bottom plate 732a, a side plate 732b, an upper partition plate 732c, and a lateral partition plate 732d. It is made of synthetic resin having a low thermal conductivity.

The configuration of the oil pan separator 732 according to the present embodiment is virtually the same as that of the abovementioned oil pan separator 532 (see FIG. 8) according to the fifth embodiment. More specifically, the first chamber 30a is substantially formed by a space (first concave or first chamber formation concave) that is enclosed by the bottom plate 732a and the side plate 732b. The second chamber 30b is formed by a space that is positioned below and laterally to the first chamber 30a. The upper end of the side plate 732b is positioned at a height that corresponds to the “F” oil level. The first oil return path according to the present invention is formed by the first chamber opening 30a1, which is open at the upper end of the side plate 732b. A flat section 732b2 is formed on the middle portion of the side plate 732b that is close to the aforementioned power train mechanism (not shown). In other words, the flat section 732b2 is formed on the right-hand portion of the side plate 732b in FIG. 10. The flat section 732b2 extends inward (toward the first chamber 30a). The upper partition plate 732c is provided with the lateral partition plate 732d, an oil return through-hole 732f, and a through-hole 732g. The lateral partition plate 732d is appropriately dimensioned as described earlier.

In the present embodiment, the thermostat valve apparatus 733 is positioned toward a portion of the side plate 732b of the oil pan separator 732 that is close to the aforementioned power train mechanism (the right-hand portion in FIG. 10). In other words, the thermostat valve apparatus 733 according to the present embodiment is positioned opposite the thermostat valve apparatuses according to the foregoing embodiments.

The oil pan separator 732 according to the present embodiment is provided with a return oil backflow valve apparatus 738. The return oil backflow valve apparatus 738 can operate in coordination with the thermostat valve apparatus 733 to supply the return oil stored in the return oil storage chamber 30d to the upper section of the second chamber 30b.

### <<Return Oil Backflow Valve Apparatus Configuration>>

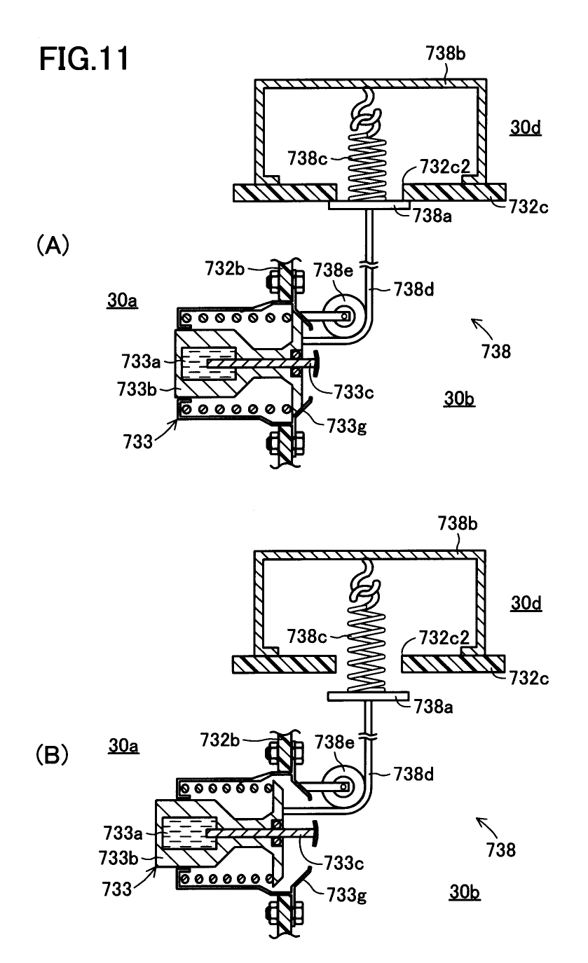

FIG. 11 are enlarged lateral cross-sectional views illustrating the return oil backflow valve apparatus 738 shown in FIG. 10. For the sake of convenience, the views shown in FIG. 11 are simplified.

The return oil backflow valve apparatus 738 comprises a valve disc 738a, a valve disc support member 738b, a coil spring 738c, a wire 738d, and a pulley 738e.

The valve disc 738a is a substantially flat member and positioned below the upper partition plate 732c. The upper partition plate 732c is provided with a communication hole 732c2 that provides communication between the second chamber 30b and the return oil storage chamber 30d. The valve disc 738a is positioned beneath the communication hole 732c2 and capable of blocking up the communication hole 732c2 from below.

The valve disc support member 738b is positioned above the valve disc 738a. The communication hole 732c2, which is provided in the upper partition plate 732c, is positioned between the valve disc 738a and the valve disc support member 738b. The valve disc support member 738b is made of a rod-like member that has an inverted U-shape (a shape like a letter of “U” which is placed upside-down). As the lower end of the valve disc support member 738b (the opening in the inverted U-shape) is brought into contact with the upper surface of the upper partition plate 732c, the valve disc support member 738b is supported by the upper section of the upper partition plate 732c.

The upper end of the coil spring 738c is hooked or otherwise fastened to the upper end of the valve disc support member 738b. The lower end of the coil spring 738c is brought into contact with the upper surface of the valve disc 738a. As shown in FIG. 11(A), the coil spring 738c has such a natural length that the valve disc 738a is constantly pulled upward while the upper surface of the valve disc 738a is in contact with the lower surface of the upper partition plate 732c. In other words, the coil spring 738c shown in FIG. 11(A) is extended to a length that is slightly greater than the natural length. The valve disc 738a, the valve disc support member 738b, and the coil spring 738c are configured so that the upper surface of the valve disc 738a blocks up the communication hole 732c2, which is provided in the upper partition plate 732c, while the upper surface of the valve disc 738a is in contact with the lower surface of the upper partition plate 732c.

The wire 738d is connected between the lower surface of the valve disc 738a and the valve body 733b of the thermostat valve apparatus 733, which is positioned below the valve disc 738a. In other words, the upper end of the wire 738d is brought into contact with the lower surface of the valve disc 738a, and the lower end of the wire 738d is brought into contact with a surface of the valve body 733b of the thermostat valve apparatus 733 that is exposed toward the second chamber 30b. A second chamber facing cover 733g, which constitutes a casing for the thermostat valve apparatus 733, supports the pulley 738e in such a manner that the pulley 738e freely rotates. The pulley 738e is a member for guiding the movement of the wire 738d and positioned to apply proper tension to the wire 738d.

As shown in FIG. 11(A), the return oil backflow valve apparatus 738 is configured so that the valve disc 738a blocks up the communication hole 732c2 when the thermostat valve apparatus 733 is closed. Further, as shown in FIG. 11(B), the return oil backflow valve apparatus 738 is configured so that when the thermostat valve apparatus 733 opens, the valve body 733b of the thermostat valve apparatus 733 moves, thereby allowing the valve disc 738a to move downward via the wire 738d and open the communication hole 732c2.

### <Operation of Seventh Embodiment>

The operation performed and advantages provided by the configuration according to the present embodiment will now be described with reference to FIGS. 10 and 11.

While a warm-up operation is being performed, the oil temperature in the first chamber 30a is lower than the valve opening temperature of the thermostat valve apparatus 733. Therefore, the thermostat valve apparatus 733, which provides the oil communication path between the first chamber 30a and the second chamber 30b, is closed (the oil communication path is closed).

In the above instance, the valve disc 738a in the return oil backflow valve apparatus 738 is pulled upward by the coil spring 738c, as indicated in FIG. 11(A), so as to block up the through-hole 732g in the upper partition plate 732c, which constitutes the bottom plate of the return oil storage chamber 30d.

When the oil temperature in the first chamber 30a rises to reach the predetermined valve opening temperature of the thermostat valve apparatus 733, as shown in FIG. 11(B), the wax 733a filled into the valve body 733b of the thermostat valve apparatus 733 thermally expands to push the rod 733c rightward as FIG. 11. The valve body 733b is then counteractively pushed leftward as indicated in FIG. 11. When the valve body 733b moves leftward as indicated in FIG. 11, the thermostat valve apparatus 733, which provides the oil communication path between the first chamber 30a and the second chamber 30b, opens (the oil communication path between the first chamber 30a and the second chamber 30b opens).

In the above instance, the valve disc 738a of the return oil backflow valve apparatus 738 is pulled downward by the wire 738d due to the movement of the valve body 733b of the thermostat valve apparatus 733, as indicated in FIG. 11(B). The valve disc 738a then moves downward against the force applied by the coil spring 738c and opens the through-hole 732g in the upper partition plate 732c, which constitutes the bottom plate of the return oil storage chamber 30d.

As described above, when the configuration according to the present embodiment is employed, the open/close operation and the degree of opening of the thermostat valve apparatus 733, which constitutes the oil communication path between the first chamber 30a and the second chamber 30b, are mechanically interlocked with the open/close operation and the degree of opening of the return oil backflow valve apparatus 738, which constitutes the second oil return path between the return oil storage chamber 30d and the second chamber 30b. Therefore, the configuration according to the present embodiment invokes oil circulation in the oil pan 730 with increased certainty after termination of a warm-up operation.

### <Exemplification of Modified Embodiments>

As mentioned earlier, the foregoing embodiments are considered to be the best by the applicant at the time of application of the present invention. They are to be considered in all respects only as illustrative and not restrictive. The present invention is not limited to the foregoing embodiments, but extends to various modifications that nevertheless fall within the scope of the appended claims.

Although some modified embodiments are additionally described below because of the existence of the first-to-file rule, they are also to be considered only as illustrative and not restrictive. Limited interpretation of the present invention, which is based on the description of the foregoing embodiments and the ensuing description of the modified embodiments, is not to be permitted because it is unduly prejudicial to the interests of the applicant who makes haste to file an application under the first-to-file rule, unrighteously profitable to imitators, and against patent law, which provides protection and use of inventions.

The modified embodiments described below may be combined as appropriate as far as no technological inconsistency arises.

(i) The oil pan configuration according to the present invention can be applied not only to the engines according to the foregoing embodiments, but also to an automatic transmission and various other apparatuses that are equipped with an oil-pan-based lubrication apparatus.

(ii) The solenoid valve 133 according to the first embodiment and the thermostat valve apparatus (e.g., the thermostat valve apparatus 233 or 333) according to the second or subsequent embodiment are interchangeable with each other. Further, a hydraulically-operated valve apparatus, pneumatically-operated valve apparatus, or another similar apparatus that is capable of controlling the open/close operation and the degree of opening in accordance with fluid pressure may be used instead of the solenoid valve or thermostat valve apparatus.

(iii) The warm-up performance and the oil circulation performance in the oil pan after a warm-up operation can be adjusted as appropriate by varying the height of the communication hole (e.g., communication hole 132f or 235f; hereinafter referred to as the communication hole). When, for instance, the communication hole is positioned higher than the “F” oil level, it is possible to store an increased amount of return oil in the second chamber 30b during a warm-up operation, increase the pressure difference between the first chamber 30a and the second chamber 30b at the end of the warm-up operation, and circulate the oil in the oil pan with increased vigorousness.

On the other hand, when the communication hole is positioned lower than the “F” oil level, the amount of return oil stored in the second chamber 30b during a warm-up operation is limited (that is, the amount of return oil flowing to the first chamber 30a is increased). Thus, the time required for a warm-up operation can be reduced. When the communication hole is roughly positioned flush with the “F” oil level, the warm-up performance and the oil circulation performance in the oil pan after a warm-up operation are balanced with each other.

(iv) A portion of the slope plate 132c for the oil pan separator 132 according to the first embodiment that overlaps with the slope plate 131c of the oil pan cover 131 may be omitted. In such an instance, it is preferred that a coat of synthetic resin, paint, or the like be applied to the slope plate 131c of the oil pan cover 131 in order to provide thermal insulation between the return oil and the oil pan cover 131, which is a metallic plate exposed to outside air.

(v) The communication hole 132f according to the first embodiment may be positioned above the side plate 132b of the oil pan separator 132.

(vi) In the second embodiment, the oil pan separator 232 may be integral with the return oil guide member 235. Further, the bottom plate 232a and the outer wall 232h may be excluded from the second embodiment. In such an instance, the inner wall 232b may be integral with the return oil guide member 235. Furthermore, the return oil guide member 235 according to the second embodiment may be divided into two pieces with one piece positioned toward the baffle plate 235j and the other piece positioned toward the communication hole 235f.

(vii) In the third embodiment, the oil pan cover 331 may be integral with the lower case 336. This also holds true for the fourth and subsequent embodiments.

(viii) In the third embodiment, the level difference between the upper partition plate 332c, which constitutes the bottom plate of the return oil storage chamber 30d, and the flange section 332b1, which is positioned toward the return oil storage chamber 30d (see FIG. 5), may be eliminated. In other words, the oil pan separator 332 may be configured so that the upper partition plate 332c, which constitutes the bottom plate of the return oil storage chamber 30d, may be flush with the flange section 332b1, which is positioned toward the return oil storage chamber 30d.

(ix) The lateral partition plate 332d may be positioned at an arbitrary height between the “F” oil level and “L” oil level. Further, the lateral partition plate 332d may be slit or holed to appropriately adjust the amount of return oil flow to the first chamber 30a during a warm-up operation (this also holds true for the fifth and subsequent embodiments).

(x) A portion of the upper partition plate 332c that provides a partition between the second chamber 30b and return oil storage chamber 30d may be provided with a small-diameter hole in addition to the through-hole 332f through which the oil level gauge 50 penetrates. The small-diameter hole does not readily permit low-temperature, high-viscosity oil to pass through during a warm-up operation but readily permits low-viscosity oil having a relatively high temperature (e.g., 60° C. or so) close to the valve opening temperature of the thermostat valve apparatus 333 to pass through a hole (the small-diameter hole is a circular hole having a diameter of approximately 3 to 7 mm or an oval or polygonal hole having an equivalent opening area).

(xi) The level gauge support 432c according to the fourth embodiment may be inclined. Further, the level gauge support 432c may be provided with the aforementioned small-diameter hole. The oil return through-hole 432f may be positioned at an arbitrary height between the “F” oil level and “L” oil level.

(xii) The configuration of the upper partition plate 532c according to the fifth embodiment may be changed as appropriate. For example, the upper partition plate 532c may be positioned slightly below the upper end of the oil pan cover 531. Further, the upper partition plate 532c may be made of a member that is separate from the oil pan separator 532. In such an instance, the upper partition plate 532c may be screwed down to, glued to, engaged with, or otherwise fastened to the oil pan cover 531 and/or oil pan separator 532. Alternatively, the upper partition plate 532c may be integral with the oil pan cover 531.

(xiii) The flat section 532b2 and the through-hole 532g may be omitted from the oil pan separator 532 according to the fifth embodiment.

(xiv) In the fifth embodiment, the first thermostat valve apparatus 533 and the second thermostat valve apparatus 538 may open virtually simultaneously or either of them may open earlier than the other. If, for instance, the second thermostat valve apparatus 538 opens earlier than the first thermostat valve apparatus 533, the pressure difference between the first chamber 30a and the second chamber 30b can be maximized when the first thermostat valve apparatus 533 opens (that is, when a warm-up operation terminates). This ensures that the oil in the second chamber 30b can vigorously flow into the first chamber 30a at the end of the warm-up operation. If the first thermostat valve apparatus 533 and the second thermostat valve apparatus 538 open virtually simultaneously, the resulting operation is the same as described in conjunction with the fifth embodiment.

(xv) In the seventh embodiment, the open/close timing difference between the thermostat valve apparatus 733 that constitutes the oil communication path between the first chamber 30a and the second chamber 30b and the return oil backflow valve apparatus 738 that constitutes the second oil return path between the return oil storage chamber 30d and the second chamber 30b can be adjusted as appropriate by changing the length, material, or configuration of the wire 738d.

(xvi) In the seventh embodiment, a solenoid valve, hydraulically-operated valve, pneumatically-operated valve, or other similar valve apparatuses whose open/close operation and degree of opening can be controlled from an external apparatus (e.g., engine control computer) may be used instead of the thermostat valve apparatus 733 and the return oil backflow valve apparatus 738. This makes it extremely easy to interlock the open/close operation and degree of opening of the oil communication path between the first chamber 30a and the second chamber 30b with the open/close operation and degree of opening of the second oil return path between the return oil storage chamber 30d and the second chamber 30b. Further, the open/close operations and degrees of opening of the above paths can be adjusted as needed with extreme ease.

(xvii) The slope plate 131c, 231c may be omitted from the first and second embodiments.

In the third to seventh embodiments, the concave sidewall constituting the first chamber 30a may be integral with the lower case 336, 436, 536, 636, 736. In other words, referring to FIG. 5, the oil pan 330 may be formed by installing a bathtub-shaped member comprising the bottom plate 331a and the side plate 331b over the underside of a bathtub-shaped member that is formed by integrating the side plate 336b, the slope plate 336c, the side plate 332b, and the bottom plate 332a into a single piece.

(xviii) It goes without saying that other various modified embodiments also fall within the scope of the present invention unless they depart from the spirit of the present invention. For example, in the foregoing embodiments, elements integrated into a single piece may be rendered integral with each other without joints or formed by gluing, depositing, screwing down, or otherwise joining a plurality of separate parts.

(xix) Functional elements constituting the “Means for Solving the Problem” include not only specific structures described in conjunction with the foregoing embodiments and modified embodiments, but also other structures that can implement the described functionality.

1-35. (canceled)

36. A lubrication apparatus capable of supplying oil for lubricating a lubrication target mechanism to the lubrication target mechanism, the lubrication apparatus comprising:
an oil pan, which includes an oil pan cover capable of storing the oil in an internal space and an oil pan separator that is positioned in the internal space to divide the internal space into a first chamber and a second chamber, which are adjacent to each other;
an oil pump for supplying oil stored in the oil pan to the lubrication target mechanism;
an oil strainer that is positioned at the inner bottom of the first chamber to constitute an oil intake port for the oil pump;
an oil communication path that is provided in the oil pan separator to vary the interchange of oil between the first chamber and the second chamber in accordance with the operation of the lubrication target mechanism;
a first oil return path capable of introducing return oil, which flows back from the lubrication target mechanism to the oil pan, to the first chamber; and
a second oil return path capable of introducing the return oil to the second chamber,
wherein the oil pan separator has a first concave that is open toward the lubrication target mechanism to constitute the first chamber;
wherein the second chamber is formed by a space that is enclosed by the oil pan cover and an outer surface of the first concave in the oil pan separator, and positioned outside the first chamber; and
wherein the first oil return path is provided to let the lubrication target mechanism communicate with the first concave.

37. The lubrication apparatus according to claim 36, further comprising:
a return oil guide section, which includes a second concave that faces and communicates with the lubrication target mechanism and is open toward the lubrication target mechanism,
wherein the bottom of the return oil guide section is provided with a first communication hole for communicating with the first chamber and a second communication hole for communicating with the second chamber;
wherein the first oil return path is formed by the first communication hole; and
wherein the second oil return path is formed by the second communication hole.

38. The lubrication apparatus according to claim 37, wherein the return oil guide section is integral with the oil pan separator.

39. The lubrication apparatus according to claim 37, wherein the oil communication path is positioned lower than the return oil guide section.

40. The lubrication apparatus according to claim 36, wherein the second oil return path includes an oil return through-hole that is provided in the oil pan separator to let the first chamber communicate with the upper section of the second chamber.

41. The lubrication apparatus according to claim 40, wherein the oil return through-hole is formed at a position corresponding to an apex of the second chamber that prevails while the lubrication target mechanism is operative.

42. The lubrication apparatus according to claim 40, wherein the oil return through-hole is formed to accept insertion of an oil level gauge that is made of a rod-like member to permit visual inspection of an oil level in the first chamber.

43. The lubrication apparatus according to claim 36, further comprising:
a return oil storage section, which includes a second concave that faces and communicates with the lubrication target mechanism and is open toward the lubrication target mechanism, and is capable of storing the return oil,
wherein the bottom of the return oil storage section is provided with a communication hole for communicating with the second chamber; and
wherein the second oil return path is formed by the communication hole.

44. The lubrication apparatus according to claim 43, further comprising: a lateral partition plate that constitutes a sidewall of the return oil storage section.

45. The lubrication apparatus according to claim 43, wherein the return oil storage section is integral with the oil pan separator.

46. The lubrication apparatus according to claim 43, wherein the oil communication path is positioned lower than the return oil storage section.

47. The lubrication apparatus according to claim 43, wherein the communication hole is formed at a position corresponding to an apex of the second chamber that prevails while the lubrication target mechanism is operative.

48. The lubrication apparatus according to claim 43, wherein the communication hole is formed to accept insertion of an oil level gauge that is made of a rod-like member to permit visual inspection of an oil level in the first chamber.

49. The lubrication apparatus according to claim 36, wherein the oil communication path is provided with a first valve that is capable of opening/closing in accordance with the temperature of the oil in the first chamber.

50. The lubrication apparatus according to claim 36, wherein the second oil return path is provided with a second valve that is capable of opening/closing in accordance with the temperature of the return oil.

51. The lubrication apparatus according to claim 50, further comprising: an open/close operation interlock section for ensuring that the open/close operation of the first valve and the open/close operation of the second valve are interlocked with each other.

52. The lubrication apparatus according to claim 51, wherein the open/close operation interlock section is made of a wire member that is installed as a bridge between the first valve and the second valve.

53. The lubrication apparatus according to claim 36, wherein the oil communication path is positioned lower than the oil level in the first chamber that prevails while the lubrication target mechanism is operative.

54. A lubrication apparatus capable of supplying oil for lubricating a lubrication target mechanism to the lubrication target mechanism, the lubrication apparatus comprising:
an oil pan, which includes an oil pan cover capable of storing the oil in an internal space and an oil pan separator that is positioned in the internal space to divide the internal space into a first chamber and a second chamber, which are adjacent to each other;
an oil pump for supplying oil stored in the oil pan to the lubrication target mechanism;
an oil strainer that is positioned at the inner bottom of the first chamber to constitute an oil intake port for the oil pump;
an oil communication path that is provided in the oil pan separator to vary the interchange of oil between the first chamber and the second chamber in accordance with the operation of the lubrication target mechanism;
a first oil return path capable of introducing return oil, which flows back from the lubrication target mechanism to the oil pan, to the first chamber;
a second oil return path capable of introducing the return oil to the second chamber; and
a return oil guide section, which includes a second concave that faces and communicates with the lubrication target mechanism and is open toward the lubrication target mechanism,
wherein the bottom of the return oil guide section is provided with a first communication hole for communicating with the first chamber and a second communication hole for communicating with the second chamber;
wherein the first oil return path is formed by the first communication hole; and
wherein the second oil return path is formed by the second communication hole.

55. The lubrication apparatus according to claim 54, wherein the return oil guide section is integral with the oil pan separator.

56. The lubrication apparatus according to claim 54, wherein the oil communication path is positioned lower than the return oil guide section.

57. The lubrication apparatus according to claim 54, wherein the oil communication path is provided with a first valve that is capable of opening/closing in accordance with the temperature of the oil in the first chamber.

58. The lubrication apparatus according to claim 54, wherein the second oil return path is provided with a second valve that is capable of opening/closing in accordance with the temperature of the return oil.

59. The lubrication apparatus according to claim 58, further comprising:
an open/close operation interlock section for ensuring that the open/close operation of the first valve and the open/close operation of the second valve are interlocked with each other.

60. The lubrication apparatus according to claim 59, wherein the open/close operation interlock section is made of a wire member that is installed as a bridge between the first valve and the second valve.

61. The lubrication apparatus according to claim 54, wherein the oil communication path is positioned lower than the oil level in the first chamber that prevails while the lubrication target mechanism is operative.

62. A lubrication apparatus capable of supplying oil for lubricating a lubrication target mechanism to the lubrication target mechanism, the lubrication apparatus comprising:
an oil pan, which includes an oil pan cover capable of storing the oil in an internal space and an oil pan separator that is positioned in the internal space to divide the internal space into a first chamber and a second chamber, which are adjacent to each other;
an oil pump for supplying oil stored in the oil pan to the lubrication target mechanism;
an oil strainer that is positioned at the inner bottom of the first chamber to constitute an oil intake port for the oil pump;
an oil communication path that is provided in the oil pan separator to vary the interchange of oil between the first chamber and the second chamber in accordance with the operation of the lubrication target mechanism;
a first oil return path capable of introducing return oil, which flows back from the lubrication target mechanism to the oil pan, to the first chamber; and
a second oil return path capable of introducing the return oil to the second chamber,
wherein the second oil return path includes an oil return through-hole that is provided in the oil pan separator to let the first chamber communicate with the upper section of the second chamber.

63. The lubrication apparatus according to claim 62, wherein the oil return through-hole is formed at a position corresponding to an apex of the second chamber that prevails while the lubrication target mechanism is operative.

64. The lubrication apparatus according to claim 63, wherein the oil return through-hole is formed to accept insertion of an oil level gauge that is made of a rod-like member to permit visual inspection of an oil level in the first chamber.

65. The lubrication apparatus according to claim 62, wherein the oil return through-hole is formed to accept insertion of an oil level gauge that is made of a rod-like member to permit visual inspection of an oil level in the first chamber.

66. The lubrication apparatus according to claim 62, wherein the oil communication path is provided with a first valve that is capable of opening/closing in accordance with the temperature of the oil in the first chamber.

67. The lubrication apparatus according to claim 62, wherein the second oil return path is provided with a second valve that is capable of opening/closing in accordance with the temperature of the return oil.

68. The lubrication apparatus according to claim 67, further comprising:
an open/close operation interlock section for ensuring that the open/close operation of the first valve and the open/close operation of the second valve are interlocked with each other.

69. The lubrication apparatus according to claim 68, wherein the open/close operation interlock section is made of a wire member that is installed as a bridge between the first valve and the second valve.

70. The lubrication apparatus according to claim 62, wherein the oil communication path is positioned lower than the oil level in the first chamber that prevails while the lubrication target mechanism is operative.

71. A lubrication apparatus capable of supplying oil for lubricating a lubrication target mechanism to the lubrication target mechanism, the lubrication apparatus comprising:
an oil pan, which includes an oil pan cover capable of storing the oil in an internal space and an oil pan separator that is positioned in the internal space to divide the internal space into a first chamber and a second chamber, which are adjacent to each other;
an oil pump for supplying oil stored in the oil pan to the lubrication target mechanism;
an oil strainer that is positioned at the inner bottom of the first chamber to constitute an oil intake port for the oil pump;
an oil communication path that is provided in the oil pan separator to vary the interchange of oil between the first chamber and the second chamber in accordance with the operation of the lubrication target mechanism;
a first oil return path capable of introducing return oil, which flows back from the lubrication target mechanism to the oil pan, to the first chamber;
a second oil return path capable of introducing the return oil to the second chamber; and
a return oil storage section, which includes a second concave that faces and communicates with the lubrication target mechanism and is open toward the lubrication target mechanism, and is capable of storing the return oil,
wherein the bottom of the return oil storage section is provided with a communication hole for communicating with the second chamber; and
wherein the second oil return path is formed by the communication hole.

72. The lubrication apparatus according to claim 71, further comprising: a lateral partition plate that constitutes a sidewall of the return oil storage section.

73. The lubrication apparatus according to claim 71, wherein the return oil storage section is integral with the oil pan separator.

74. The lubrication apparatus according to claim 71, wherein the oil communication path is positioned lower than the return oil storage section.

75. The lubrication apparatus according to claim 71, wherein the communication hole is formed at a position corresponding to an apex of the second chamber that prevails while the lubrication target mechanism is operative.

76. The lubrication apparatus according to claim 71, wherein the communication hole is formed to accept insertion of an oil level gauge that is made of a rod-like member to permit visual inspection of an oil level in the first chamber.

77. The lubrication apparatus according to claim 71, wherein the oil communication path is provided with a first valve that is capable of opening/closing in accordance with the temperature of the oil in the first chamber.

78. The lubrication apparatus according to claim 71, wherein the second oil return path is provided with a second valve that is capable of opening/closing in accordance with the temperature of the return oil.

79. The lubrication apparatus according to claim 78, further comprising:
an open/close operation interlock section for ensuring that the open/close operation of the first valve and the open/close operation of the second valve are interlocked with each other.

80. The lubrication apparatus according to claim 79, wherein the open/close operation interlock section is made of a wire member that is installed as a bridge between the first valve and the second valve.

81. The lubrication apparatus according to claim 71, wherein the oil communication path is positioned lower than the oil level in the first chamber that prevails while the lubrication target mechanism is operative.

82. A lubrication apparatus capable of supplying oil for lubricating a lubrication target mechanism to the lubrication target mechanism, the lubrication apparatus comprising:
an oil pan, which includes an oil pan cover capable of storing the oil in an internal space and an oil pan separator that is positioned in the internal space to divide the internal space into a first chamber and a second chamber, which are adjacent to each other;
an oil pump for supplying oil stored in the oil pan to the lubrication target mechanism;
an oil strainer that is positioned at the inner bottom of the first chamber to constitute an oil intake port for the oil pump;
an oil communication path that is provided in the oil pan separator to vary the interchange of oil between the first chamber and the second chamber in accordance with the operation of the lubrication target mechanism;
a first oil return path capable of introducing return oil, which flows back from the lubrication target mechanism to the oil pan, to the first chamber; and
a second oil return path capable of introducing the return oil to the second chamber,
wherein the second oil return path is provided with a second valve that is capable of opening/closing in accordance with the temperature of the return oil.

83. The lubrication apparatus according to claim 82, further comprising:
an open/close operation interlock section for ensuring that the open/close operation of the first valve and the open/close operation of the second valve are interlocked with each other.

84. The lubrication apparatus according to claim 83, wherein the open/close operation interlock section is made of a wire member that is installed as a bridge between the first valve and the second valve.

85. The lubrication apparatus according to claim 82, wherein the oil communication path is positioned lower than the oil level in the first chamber that prevails while the lubrication target mechanism is operative.

86. A lubrication apparatus capable of supplying oil for lubricating a lubrication target mechanism to the lubrication target mechanism, the lubrication apparatus comprising:
an oil pan, which includes an oil pan cover capable of storing the oil in an internal space and an oil pan separator that is positioned in the internal space to divide the internal space into a first chamber and a second chamber, which are adjacent to each other;
an oil pump for supplying oil stored in the oil pan to the lubrication target mechanism;
an oil strainer that is positioned at the inner bottom of the first chamber to constitute an oil intake port for the oil pump;
an oil communication path that is provided in the oil pan separator to vary the interchange of oil between the first chamber and the second chamber in accordance with the operation of the lubrication target mechanism; and
an oil return path capable of introducing return oil, which flows back from the lubrication target mechanism to the oil pan, to the second chamber,
wherein the oil pan separator has a first chamber formation concave that is open toward the lubrication target mechanism to constitute the first chamber; and
wherein the second chamber is formed by a space that is enclosed by the oil pan cover and an outer surface of the first chamber formation concave in the oil pan separator, and positioned outside the first chamber.

87. The lubrication apparatus according to claim 86, wherein the oil return path includes an oil return through-hole that is provided in the oil pan separator to let the first chamber communicate with the upper section of the second chamber.

88. The lubrication apparatus according to claim 87, wherein the oil return through-hole is formed at a position corresponding to an apex of the second chamber that prevails while the lubrication target mechanism is operative.

89. The lubrication apparatus according to claim 87, wherein the oil return through-hole is formed to accept insertion of an oil level gauge that is made of a rod-like member to permit visual inspection of an oil level in the first chamber.

90. The lubrication apparatus according to claim 86, further comprising:
a return oil storage section, which includes a return oil storage concave that faces and communicates with the lubrication target mechanism and is open toward the lubrication target mechanism, and is capable of storing the return oil,
wherein the bottom of the return oil storage section is provided with a communication hole for communicating with the second chamber; and wherein the oil return path is formed by the communication hole.

91. The lubrication apparatus according to claim 90, further comprising: a lateral partition plate that constitutes a sidewall of the return oil storage section.

92. The lubrication apparatus according to claim 90, wherein the return oil storage section is integral with the oil pan separator.

93. The lubrication apparatus according to claim 90, wherein the oil communication path is positioned lower than the return oil storage section.

94. The lubrication apparatus according to claim 90, wherein the communication hole is formed at a position corresponding to an apex of the second chamber that prevails while the lubrication target mechanism is operative.

95. The lubrication apparatus according to claim 90, wherein the communication hole is formed to accept insertion of an oil level gauge that is made of a rod-like member to permit visual inspection of an oil level in the first chamber.

96. The lubrication apparatus according to claim 86, wherein the oil communication path is provided with a first valve that is capable of opening/closing in accordance with the temperature of the oil in the first chamber.

97. The lubrication apparatus according to claim 86, wherein the oil return path is provided with a second valve that is capable of opening/closing in accordance with the temperature of the return oil.

98. The lubrication apparatus according to claim 97, further comprising:
an open/close operation interlock section for ensuring that the open/close operation of the first valve and the open/close operation of the second valve are interlocked with each other.

99. The lubrication apparatus according to claim 98, wherein the open/close operation interlock section is made of a wire member that is installed as a bridge between the first valve and the second valve.

100. The lubrication apparatus according to claim 99, wherein the oil communication path is positioned lower than the oil return path.

101. A lubrication apparatus capable of supplying oil for lubricating a lubrication target mechanism to the lubrication target mechanism, the lubrication apparatus comprising:
an oil pan, which includes an oil pan cover capable of storing the oil in an internal space and an oil pan separator that is positioned in the internal space to divide the internal space into a first chamber and a second chamber, which are adjacent to each other;
an oil pump for supplying oil stored in the oil pan to the lubrication target mechanism;
an oil strainer that is positioned at the inner bottom of the first chamber to constitute an oil intake port for the oil pump;
an oil communication path that is provided in the oil pan separator to vary the interchange of oil between the first chamber and the second chamber in accordance with the operation of the lubrication target mechanism; and
an oil return path capable of introducing return oil, which flows back from the lubrication target mechanism to the oil pan, to the second chamber,
wherein the oil return path includes an oil return through-hole that is provided in the oil pan separator to let the first chamber communicate with the upper section of the second chamber.

102. The lubrication apparatus according to claim 101, wherein the oil return through-hole is formed at a position corresponding to an apex of the second chamber that prevails while the lubrication target mechanism is operative.

103. The lubrication apparatus according to claim 101, wherein the oil return through-hole is formed to accept insertion of an oil level gauge that is made of a rod-like member to permit visual inspection of an oil level in the first chamber.

104. The lubrication apparatus according to claim 101, wherein the oil communication path is provided with a first valve that is capable of opening/closing in accordance with the temperature of the oil in the first chamber.

105. The lubrication apparatus according to claim 101, wherein the oil return path is provided with a second valve that is capable of opening/closing in accordance with the temperature of the return oil.

106. The lubrication apparatus according to claim 105, further comprising:
an open/close operation interlock section for ensuring that the open/close operation of the first valve and the open/close operation of the second valve are interlocked with each other.

107. The lubrication apparatus according to claim 106, wherein the open/close operation interlock section is made of a wire member that is installed as a bridge between the first valve and the second valve.

108. The lubrication apparatus according to claim 107, wherein the oil communication path is positioned lower than the oil return path.

109. A lubrication apparatus capable of supplying oil for lubricating a lubrication target mechanism to the lubrication target mechanism, the lubrication apparatus comprising:
an oil pan, which includes an oil pan cover capable of storing the oil in an internal space and an oil pan separator that is positioned in the internal space to divide the internal space into a first chamber and a second chamber, which are adjacent to each other;
an oil pump for supplying oil stored in the oil pan to the lubrication target mechanism;
an oil strainer that is positioned at the inner bottom of the first chamber to constitute an oil intake port for the oil pump;
an oil communication path that is provided in the oil pan separator to vary the interchange of oil between the first chamber and the second chamber in accordance with the operation of the lubrication target mechanism; and
an oil return path capable of introducing return oil, which flows back from the lubrication target mechanism to the oil pan, to the second chamber; and
a return oil storage section, which includes a return oil storage concave that faces and communicates with the lubrication target mechanism and is open toward the lubrication target mechanism, and is capable of storing the return oil,
wherein the bottom of the return oil storage section is provided with a communication hole for communicating with the second chamber; and wherein the oil return path is formed by the communication hole.

110. The lubrication apparatus according to claim 109, further comprising: a lateral partition plate that constitutes a sidewall of the return oil storage section.

111. The lubrication apparatus according to claim 109, wherein the return oil storage section is integral with the oil pan separator.

112. The lubrication apparatus according to claim 109, wherein the oil communication path is positioned lower than the return oil storage section.

113. The lubrication apparatus according to claim 109, wherein the communication hole is formed at a position corresponding to an apex of the second chamber that prevails while the lubrication target mechanism is operative.

114. The lubrication apparatus according to claim 109, wherein the communication hole is formed to accept insertion of an oil level gauge that is made of a rod-like member to permit visual inspection of an oil level in the first chamber.

115. The lubrication apparatus according to claim 109, wherein the oil communication path is provided with a first valve that is capable of opening/closing in accordance with the temperature of the oil in the first chamber.

116. The lubrication apparatus according to claim 109, wherein the oil return path is provided with a second valve that is capable of opening/closing in accordance with the temperature of the return oil.

117. The lubrication apparatus according to claim 116, further comprising:
an open/close operation interlock section for ensuring that the open/close operation of the first valve and the open/close operation of the second valve are interlocked with each other.

118. The lubrication apparatus according to claim 117, wherein the open/close operation interlock section is made of a wire member that is installed as a bridge between the first valve and the second valve.

119. The lubrication apparatus according to claim 118, wherein the oil communication path is positioned lower than the oil return path.

120. A lubrication apparatus capable of supplying oil for lubricating a lubrication target mechanism to the lubrication target mechanism, the lubrication apparatus comprising:
an oil pan, which includes an oil pan cover capable of storing the oil in an internal space and an oil pan separator that is positioned in the internal space to divide the internal space into a first chamber and a second chamber, which are adjacent to each other;
an oil pump for supplying oil stored in the oil pan to the lubrication target mechanism;
an oil strainer that is positioned at the inner bottom of the first chamber to constitute an oil intake port for the oil pump;
an oil communication path that is provided in the oil pan separator to vary the interchange of oil between the first chamber and the second chamber in accordance with the operation of the lubrication target mechanism; and
an oil return path capable of introducing return oil, which flows back from the lubrication target mechanism to the oil pan, to the second chamber,
wherein the oil return path is provided with a second valve that is capable of opening/closing in accordance with the temperature of the return oil.

121. The lubrication apparatus according to claim 120, further comprising:
an open/close operation interlock section for ensuring that the open/close operation of the first valve and the open/close operation of the second valve are interlocked with each other.

122. The lubrication apparatus according to claim 121, wherein the open/close operation interlock section is made of a wire member that is installed as a bridge between the first valve and the second valve.

123. The lubrication apparatus according to claim 122, wherein the oil communication path is positioned lower than the oil return path.
